(19) United States
(12) Patent Application Publication
(10) Pub. No.: US 2025/0097956 A1
(43) Pub. Date: Mar. 20, 2025

(54) TRANSMISSION CONFIGURATION INDICATOR STATE IDENTIFICATION IN WIRELESS COMMUNICATIONS

(71) Applicant: QUALCOMM INCORPORATED, San Diego, CA (US)

(72) Inventors: Mostafa Khoshnevisan, San Diego, CA (US); Yan Zhou, San Diego, CA (US); Fang Yuan, Beijing (CN); Tao Luo, San Diego, CA (US); Xiaoxia Zhang, San Diego, CA (US)

(21) Appl. No.: 18/715,029

(22) PCT Filed: Jan. 19, 2022
(86) PCT No.: PCT/CN2022/072737

§ 371 Date: May 30, 2024

(51) Int. Cl. H04W 72/232; H04L 5/00

(52) U.S. Cl. CPC H04W 72/232; H04L 5/0094

(57) ABSTRACT

Methods, systems, and devices for wireless communications are described. A UE may receive, from a network entity, control signaling identifying two or more transmission configuration indicator states that are to be applied to communications of one or more channels subsequent to a determined time; receive, from the network entity, control information associated with one or more resource allocations for communications after the determined time; and communicate via the one or more channels according to a first transmission configuration indicator state of the two or more transmission configuration indicator states based at least in part on a parameter associated with the control information and the two or more transmission configuration indicator states.

### CROSS REFERENCE

The present Application is a 371 national stage filing of International PCT Application No. PCT/CN2022/072737 by Khoshnevisan et al. entitled “TRANSMISSION CONFIGURATION INDICATOR STATE IDENTIFICATION IN WIRELESS COMMUNICATIONS,” filed Jan. 19, 2022, which is assigned to the assignee hereof, and which is expressly incorporated by reference in its entirety herein.

### TECHNICAL FIELD

The following relates to wireless communications, including transmission configuration indicator state identification in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some systems, UEs and base station may use one or more beam configurations for communications. Such beam configurations may be indicated by a transmission configuration indicator (TCI) state, where a UE and base station may use one or more TCI states for uplink communications, downlink communications, or both. Efficient techniques for managing TCI states for communications may help to enhance communications efficiency and reliability, and may reduce communications latency.

### SUMMARY

The described techniques relate to improved methods, systems, devices, and apparatuses that support transmission configuration indicator state (TCI) identification in wireless communications. In accordance with various aspects, techniques are described for configuration of multiple TCI states and selection of a particular TCI state or TCI states of the multiple configured TCI states to be used for communications between a user equipment (UE) and one or more transmission-reception points (TRPs) or base stations. In some cases, a UE may be configured with two TCI states for communications (e.g., based on a configured TCI codepoint that is associated with two TCI states). A base station or other network entity transmit control information (e.g., downlink control information (DCI)) to the UE that may provide a resource allocation for one or more communications and, in some cases, the control information may be used to determine the particular TCI state(s) for the associated communications.

In some cases, a format of the control information (e.g., a DCI format) may indicate the TCI state(s) to be applied to the associated communications. In some cases, a payload field in the control information may indicate the TCI state(s). In some further cases, a number of scheduled repetitions indicated in the control information may indicate the TCI state(s). In some further cases, a control channel candidate or control resource set (CORESET) associated with the control information may indicate the TCI state(s). In still further cases, a priority associated with a communication instance of the control information may indicate the TCI state(s). Various techniques discussed herein also may be applied to periodic communications (e.g., semi-persistent scheduling (SPS) communications or configured grant (CG) communications), where control information that activates communications (e.g., an activating DCI) may be used to indicate one or more TCI states.

A method for wireless communication at a user equipment (UE) is described. The method may include receiving, from a network entity, control signaling identifying two or more transmission configuration indicator states that are to be applied to communications of one or more channels subsequent to a determined time, receiving, from the network entity, control information associated with one or more resource allocations for communications after the determined time, and communicating via the one or more channels according to a first transmission configuration indicator state of the two or more transmission configuration indicator states based on a parameter associated with the control information and the two or more transmission configuration indicator states.

An apparatus for wireless communication at a UE is described. The apparatus may include at least one processor, and memory coupled to the at least one processor, the memory storing instructions executable by the at least one processor to cause the apparatus to receive, from a network entity, control signaling identifying two or more transmission configuration indicator states that are to be applied to communications of one or more channels subsequent to a determined time, receive, from the network entity, control information associated with one or more resource allocations for communications after the determined time, and communicate via the one or more channels according to a first transmission configuration indicator state of the two or more transmission configuration indicator states based on a parameter associated with the control information and the two or more transmission configuration indicator states.

Another apparatus for wireless communication at a UE is described. The apparatus may include means for receiving, from a network entity, control signaling identifying two or more transmission configuration indicator states that are to be applied to communications of one or more channels subsequent to a determined time, means for receiving, from the network entity, control information associated with one or more resource allocations for communications after the determined time, and means for communicating via the one or more channels according to a first transmission configuration indicator state of the two or more transmission configuration indicator states based on a parameter associated with the control information and the two or more transmission configuration indicator states.

A non-transitory computer-readable medium storing code for wireless communication at a UE is described. The code may include instructions executable by a processor to receive, from a network entity, control signaling identifying two or more transmission configuration indicator states that are to be applied to communications of one or more channels subsequent to a determined time, receive, from the network entity, control information associated with one or more resource allocations for communications after the determined time, and communicate via the one or more channels according to a first transmission configuration indicator state of the two or more transmission configuration indicator states based on a parameter associated with the control information and the two or more transmission configuration indicator states.

In some examples of the method, apparatuses, and non-transitory computer-readable medium described herein, the two or more transmission configuration indicator states provide for multi-transmission reception point communications with two or more transmission reception points associated with the network entity. In some examples of the method, apparatuses, and non-transitory computer-readable medium described herein, the receiving the control information may include operations, features, means, or instructions for receiving downlink control information (DCI) having a first DCI format that indicates the first transmission configuration indicator state for at least a first communication via the one or more channels, and where a second DCI format is associated with both the first transmission configuration indicator state and a second transmission configuration indicator state for communications via the one or more channels. In some examples of the method, apparatuses, and non-transitory computer-readable medium described herein, the first DCI format may be associated with a first subset of DCI formats that schedule single transmission reception point communications using the first transmission configuration indicator state, and the second DCI format may be associated with a second subset of DCI formats that schedule multi-transmission reception point communications using both the first transmission configuration indicator state and the second transmission configuration indicator state.

Some examples of the method, apparatuses, and non-transitory computer-readable medium described herein may further include operations, features, means, or instructions for receiving configuration information that maps the first DCI format to the first transmission configuration indicator state, and that maps the second DCI format to both the first transmission configuration indicator state and the second transmission configuration indicator state.

In some examples of the method, apparatuses, and non-transitory computer-readable medium described herein, the first transmission configuration indicator state applies to physical downlink shared channel (PDSCH) communications, physical uplink control channel (PUCCH) communications, physical uplink shared channel (PUSCH) communications, or any combinations thereof, that are scheduled by the first DCI format and both the first transmission configuration indicator state and the second transmission configuration indicator state apply to PDSCH communications, PUCCH communications, PUSCH communications, or any combinations thereof, that are scheduled by the second DCI format.

In some examples of the method, apparatuses, and non-transitory computer-readable medium described herein, the receiving the control information may include operations, features, means, or instructions for receiving DCI having a DCI payload that indicates the first transmission configuration indicator state for at least a first communication via the one or more channels, or that indicates both the first transmission configuration indicator state and a second transmission configuration indicator state for communications via the one or more channels. In some examples of the method, apparatuses, and non-transitory computer-readable medium described herein, the DCI payload may be a one-bit field that indicates to use the first transmission configuration indicator state or to use both the first transmission configuration indicator state and the second transmission configuration indicator state. In some examples of the method, apparatuses, and non-transitory computer-readable medium described herein, the DCI payload may be a two-bit field that indicates to use the first transmission configuration indicator state, to use the second transmission configuration indicator state for communications with a second transmission reception point, or to use both the first transmission configuration indicator state and the second transmission configuration indicator state. In some examples of the method, apparatuses, and non-transitory computer-readable medium described herein, the two-bit field further indicates an order for applying the first transmission configuration indicator state and the second transmission configuration indicator state to a first resource allocation of a first channel of the one or more channels and a second resource allocation or a second channel of the one or more channels.

In some examples of the method, apparatuses, and non-transitory computer-readable medium described herein, the receiving the control information may include operations, features, means, or instructions for receiving an indication of a number of repetitions of each communication are to be provided in the one or more resource allocations, and where first number of repetitions indicates the first transmission configuration indicator state for at least a first communication via the one or more channels, and a second number of repetitions indicates both the first transmission configuration indicator state and a second transmission configuration indicator state for communications via the one or more channels. In some examples of the method, apparatuses, and non-transitory computer-readable medium described herein, the first transmission configuration indicator state used when the number of repetitions is a single repetition, and both the first transmission configuration indicator state and the second transmission configuration indicator state may be used when the number of repetitions is two or more repetitions.

Some examples of the method, apparatuses, and non-transitory computer-readable medium described herein may further include operations, features, means, or instructions for identifying a control channel decoding candidate or a control resource set that is associated with the control information, and where a first subset of control channel decoding candidates or a first subset of control resource sets is associated with the first transmission configuration indicator state for communications via the one or more channels, and a second subset of control channel decoding candidates or a second subset of control resource sets is associated with both the first transmission configuration indicator state and a second transmission configuration indicator state for communications via the one or more channels. In some examples of the method, apparatuses, and non-transitory computer-readable medium described herein, the first transmission configuration indicator state is associated with a single control channel decoding candidate, and both the first transmission configuration indicator state and the second transmission configuration indicator state is associated with multiple control channel decoding candidates for the control information, where the multiple control channel decoding candidates are linked for control information repetition across the multiple control channel decoding candidates. In some examples of the method, apparatuses, and non-transitory computer-readable medium described herein, the first subset of control resource sets are associated with a single transmission configuration indicator state, and the second subset of control resource sets are associated with multiple transmission configuration indicator states.

In some examples of the method, apparatuses, and non-transitory computer-readable medium described herein, the receiving the control information may include operations, features, means, or instructions for receiving, with the control information, an indication of a priority of one or more associated communications, and where first priority indicates the first transmission configuration indicator state for at least a first communication with a first transmission reception point, and a second priority indicates both the first transmission configuration indicator state and a second transmission configuration indicator state for communications with two or more transmission reception points. In some examples of the method, apparatuses, and non-transitory computer-readable medium described herein, the control information may be a scheduling DCI that indicates allocated resources for communications, or may be an activation DCI that activates communication using previously configured resources.

In some examples of the method, apparatuses, and non-transitory computer-readable medium described herein, the two or more transmission configuration indicator states may be associated with multi-transmission reception point communications with two or more transmission reception points according to a time division multiplexing communications scheme, a frequency division multiplexing communications scheme, a spatial division multiplexing communications scheme, or a single frequency network communications scheme. In some examples of the method, apparatuses, and non-transitory computer-readable medium described herein, the one or more channels include a downlink shared channel, uplink shared channel, uplink control channel, or any combinations thereof, and where and the control signaling includes one or more of downlink control information having a first format with a transmission configuration indicator state field, or a medium access control (MAC) control element that indicates a single transmission configuration indicator codepoint that is mapped to the two or more transmission configuration indicator states.

A method for wireless communication at a network entity is described. The method may include transmitting, to a UE, control signaling identifying two or more transmission configuration indicator states that are to be applied to communications of one or more channels subsequent to a determined time, transmitting, to the UE, control information associated with one or more resource allocations for communications after the determined time, and communicating with the UE via the one or more channels according to a first transmission configuration indicator state of the two or more transmission configuration indicator states based on a parameter associated with the control information and the two or more transmission configuration indicator states.

An apparatus for wireless communication at a network entity is described. The apparatus may include at least one processor, and memory coupled to the at least one processor, the memory storing instructions executable by the at least one processor to cause the apparatus to transmit, to a UE, control signaling identifying two or more transmission configuration indicator states that are to be applied to communications of one or more channels subsequent to a determined time, transmit, to the UE, control information associated with one or more resource allocations for communications after the determined time, and communicate with the UE via the one or more channels according to a first transmission configuration indicator state of the two or more transmission configuration indicator states based on a parameter associated with the control information and the two or more transmission configuration indicator states.

Another apparatus for wireless communication at a network entity is described. The apparatus may include means for transmitting, to a UE, control signaling identifying two or more transmission configuration indicator states that are to be applied to communications of one or more channels subsequent to a determined time, means for transmitting, to the UE, control information associated with one or more resource allocations for communications after the determined time, and means for communicating with the UE via the one or more channels according to a first transmission configuration indicator state of the two or more transmission configuration indicator states based on a parameter associated with the control information and the two or more transmission configuration indicator states.

A non-transitory computer-readable medium storing code for wireless communication at a network entity is described. The code may include instructions executable by a processor to transmit, to a UE, control signaling identifying two or more transmission configuration indicator states that are to be applied to communications of one or more channels subsequent to a determined time, transmit, to the UE, control information associated with one or more resource allocations for communications after the determined time, and communicate with the UE via the one or more channels according to a first transmission configuration indicator state of the two or more transmission configuration indicator states based on a parameter associated with the control information and the two or more transmission configuration indicator states.

In some examples of the method, apparatuses, and non-transitory computer-readable medium described herein, the transmitting the control information may include operations, features, means, or instructions for transmitting DCI having a first DCI format that indicates the first transmission configuration indicator state for at least a first communication via the one or more channels, and where a second DCI format is associated with both the first transmission configuration indicator state and a second transmission configuration indicator state for communications via the one or more channels. In some examples of the method, apparatuses, and non-transitory computer-readable medium described herein, the transmitting the control information may include operations, features, means, or instructions for transmitting DCI having a DCI payload that indicates the first transmission configuration indicator state for at least a first communication via the one or more channels, or that indicates both the first transmission configuration indicator state and a second transmission configuration indicator state for communications via the one or more channels.

In some examples of the method, apparatuses, and non-transitory computer-readable medium described herein, the transmitting the control information may include operations, features, means, or instructions for transmitting an indication of a number of repetitions of each communication are to be provided in the one or more resource allocations, and where first number of repetitions indicates the first transmission configuration indicator state for at least a first communication via the one or more channels, and a second number of repetitions indicates both the first transmission configuration indicator state and a second transmission configuration indicator state for communications via the one or more channels.

In some examples of the method, apparatuses, and non-transitory computer-readable medium described herein, a first subset of control channel decoding candidates or a first subset of control resource sets used for providing the control information may be associated with the first transmission configuration indicator state for communications via the one or more channels, and a second subset of control channel decoding candidates or a second subset of control resource sets may be associated with both the first transmission configuration indicator state and a second transmission configuration indicator state for communications via the one or more channels. In some examples of the method, apparatuses, and non-transitory computer-readable medium described herein, the transmitting the control information may include operations, features, means, or instructions for transmitting, with the control information, an indication of a priority of one or more associated communications, and where first priority indicates the first transmission configuration indicator state for at least a first communication via the one or more channels, and a second priority indicates both the first transmission configuration indicator state and a second transmission configuration indicator state for communications via the one or more channels.

### BRIEF DESCRIPTION OF THE DRAWINGS

FIG. 1 illustrates an example of a wireless communications system that supports transmission configuration indicator state identification in wireless communications in accordance with aspects of the present disclosure.

FIG. 2 illustrates an example of a wireless communications system that supports transmission configuration indicator state identification in wireless communications in accordance with aspects of the present disclosure.

FIG. 3 illustrates an example of multiplexing schemes for transmission configuration indicator (TCI) states in accordance with aspects of the present disclosure.

FIGS. 4 through 9 illustrate examples of TCI state indications based on control information in accordance with aspects of the present disclosure.

FIG. 10 illustrates an example of a process flow that supports transmission configuration indicator state identification in wireless communications in accordance with aspects of the present disclosure.

FIGS. 11 and 12 show block diagrams of devices that support transmission configuration indicator state identification in wireless communications in accordance with aspects of the present disclosure.

FIG. 13 shows a block diagram of a communications manager that supports transmission configuration indicator state identification in wireless communications in accordance with aspects of the present disclosure.

FIG. 14 shows a diagram of a system including a device that supports transmission configuration indicator state identification in wireless communications in accordance with aspects of the present disclosure.

FIGS. 15 and 16 show block diagrams of devices that support transmission configuration indicator state identification in wireless communications in accordance with aspects of the present disclosure.

FIG. 17 shows a block diagram of a communications manager that supports transmission configuration indicator state identification in wireless communications in accordance with aspects of the present disclosure.

FIG. 18 shows a diagram of a system including a device that supports transmission configuration indicator state identification in wireless communications in accordance with aspects of the present disclosure.

FIGS. 19 through 25 show flowcharts illustrating methods that support transmission configuration indicator state identification in wireless communications in accordance with aspects of the present disclosure.

### DETAILED DESCRIPTION

Implementations described herein provide techniques for indicating a number of activated TCI states, and types of TCI states, using a codepoint that is provided to a user equipment (UE). In some cases, codepoints may be configured at a UE, and a particular codepoint may be indicated to the UE (e.g., in a medium access control (MAC) control element (CE)) and one or more associated TCIs may be used for communications until a subsequent different codepoint is indicated to the UE (e.g., an indication of a TCI codepoint is a “sticky” indication that is used for communications until changed). In some cases, each codepoint may include one or two TCI states, and each respective TCI state identifier in the codepoint may correspond to a TCI state type, such as uplink, downlink, or both. For example, one TCI state or multiple TCI states may be mapped to a single TCI codepoint, where the single TCI codepoint also indicates respective TCI state types for the activated TCI states. In some implementations, the base station (or other network entity) may configure two separate TCI state lists, one for downlink TCI states and one for uplink TCI states. Each codepoint may include one or multiple TCI state identifiers, and an indication of one of the two configured lists with which the TCI state identifier is associated.

In some cases, when a TCI codepoint is associated with multiple TCI states, only a single TCI state may be needed for communications. For example, a UE may be configured with multiple TCI states for communications with two or more transmission-reception points (TRPs), where a first TCI state is for communications with a first TRP and a second TCI state is for communications with a second TRP (e.g., according to a multiplexing scheme). For certain communications, however, multiple-TRP (mTRP) communications may not be scheduled (e.g., if a fallback downlink control information (DCI) format is used, it cannot schedule mTRP), or wireless resources may be scheduled when both TRPs are not available. In accordance with various techniques discussed herein, selection of a TCI state or states in such cases may be based on one or more indications provided to a UE.

In some cases, a UE may be configured with multiple TCI states for communications (e.g., based on a configured TCI codepoint that is associated with two TCI states). A base station or other network entity may transmit control information (e.g., DCI) to the UE that may provide a resource allocation for one or more communications and, in some cases, the control information may be used to determine the particular TCI state(s) for the associated communications. In some cases, the control information may indicate TCI state(s) for a communication based at least in part on one or more of a format of the control information (e.g., a DCI format), a payload field in the control information, a number of scheduled repetitions indicated in the control information, a control channel candidate or control resource set (CORESET) associated with the control information, a priority associated with a scheduled communication, or any combinations thereof. Various techniques discussed herein also may be applied to periodic communications (e.g., semi-persistent scheduling (SPS) communications or configured grant (CG) communications), where control information that activates communications (e.g., an activating DCI) may be used to indicate one or more TCI states.

Particular implementations of the subject matter described in this disclosure can be implemented to realize one or more of the following potential advantages. For example, a single TCI codepoint may be mapped with two TCI states and indicated with TCI state types, and one or more particular TCI states may be selected for a one or more communications. By indicating the TCI state types corresponding to the mapped TCI states in a single codepoint, signaling overhead may be reduced. Further, described techniques may support increased flexibility for a UE, because the base station may be able to activate more TCI states of different types (such as, joint or separate TCI states) without a corresponding increase in signaling. This may result in more efficient use of spatial resources, as well as decreased collisions and interference, without introducing signaling delays and increased system latency. Thus, described techniques may result increased reliability of communications and improved user experience. Further, described techniques may support flexible and efficient indications of TCI states supporting mTRP communications, resulting in more efficient and reliable communications and decreased signaling overhead.

Aspects of the disclosure are initially described in the context of wireless communications systems. Aspects of the disclosure are further illustrated by and described with reference to TCI multiplexing schemes, TCI state indications and timing, process flows, apparatus diagrams, system diagrams, and flowcharts that relate to transmission configuration indicator state identification in wireless communications.

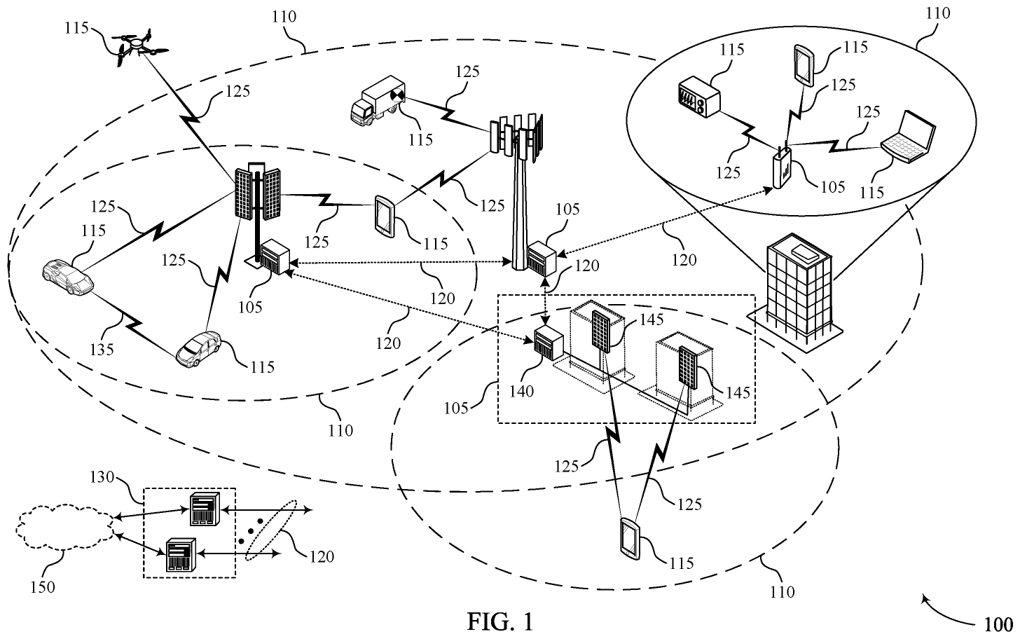

FIG. 1 illustrates an example of a wireless communications system 100 that supports transmission configuration indicator state identification in wireless communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may also refer to a wireless local loop (WLL) station, an Internet of Things (IoT) device, an Internet of Everything (IoE) device, or an MTC device, or the like, which may be implemented in various articles such as appliances, drones, robots, vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHZ, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some cases, a UE 115 may be configured with multiple TCI states for communications (e.g., based on a configured TCI codepoint that is associated with two TCI states). A base station 105 or other network entity may transmit control information (e.g., DCI) to the UE 115 that may provide a resource allocation for one or more communications and, in some cases, the control information may be used to determine the particular TCI state(s) for the associated communications. In some cases, the control information may indicate TCI state(s) for a communication based at least in part on one or more of a format of the control information (e.g., a DCI format), a payload field in the control information, a number of scheduled repetitions indicated in the control information, a control channel candidate or CORESET associated with the control information, a priority associated with a scheduled communication, or any combinations thereof. Various techniques discussed herein also may be applied to periodic communications (e.g., SPS communications or CG communications), where control information that activates communications (e.g., an activating DCI) may be used to indicate one or more TCI states.

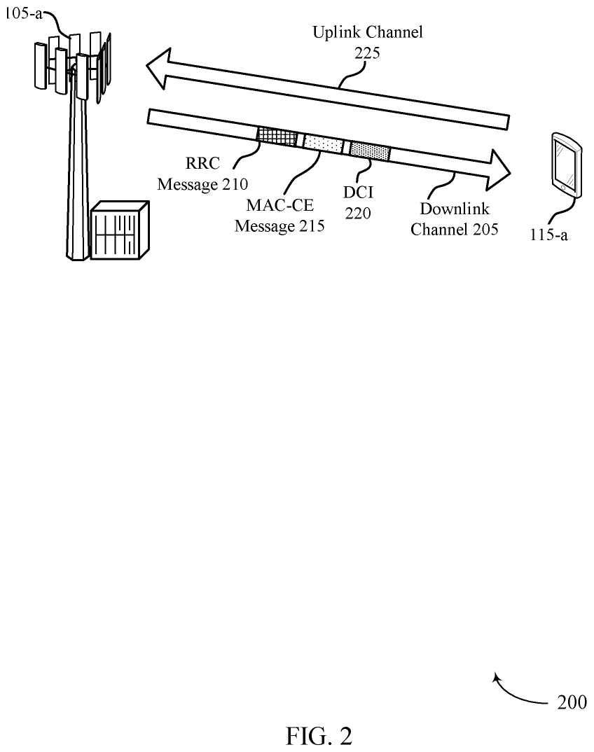

FIG. 2 illustrates an example of a wireless communications system 200 that supports transmission configuration indicator state identification in wireless communications in accordance with aspects of the present disclosure. The wireless communications system 200 may be an example of the wireless communications system 100. For example, the wireless communications system 200 may include a UE 115-a and a base station 105-a, which may be examples of the UE 115 and the base station 105 as described with reference to FIG. 1. While examples are discussed herein, any number of devices and device types may be used to accomplish implementations described in the present disclosure. As used herein, the term beam configuration may be referred to as a TCI state, and the term TCI state may be referred to as a beam configuration.

The base station 105-a and the UE 115-a may communicate via a downlink channel 205 and an uplink channel 225. In some wireless communications systems, such as 5G or NR, different types of TCI states may be used to improve channel utilization between wireless devices. For example, a wireless communications system may support joint TCI states for both downlink and uplink signaling using a unified TCI framework. In some systems, wireless communications systems may support a single TCI codepoint that is mapped to multiple TCI states, such as one downlink TCI state and one uplink TCI state. However, as discussed herein, such techniques may not clearly indicate the TCI state type of a pair of TCI states, such as joint downlink and uplink TCI states, separate uplink or downlink TCI states, common uplink or downlink TCI states, for some communications.

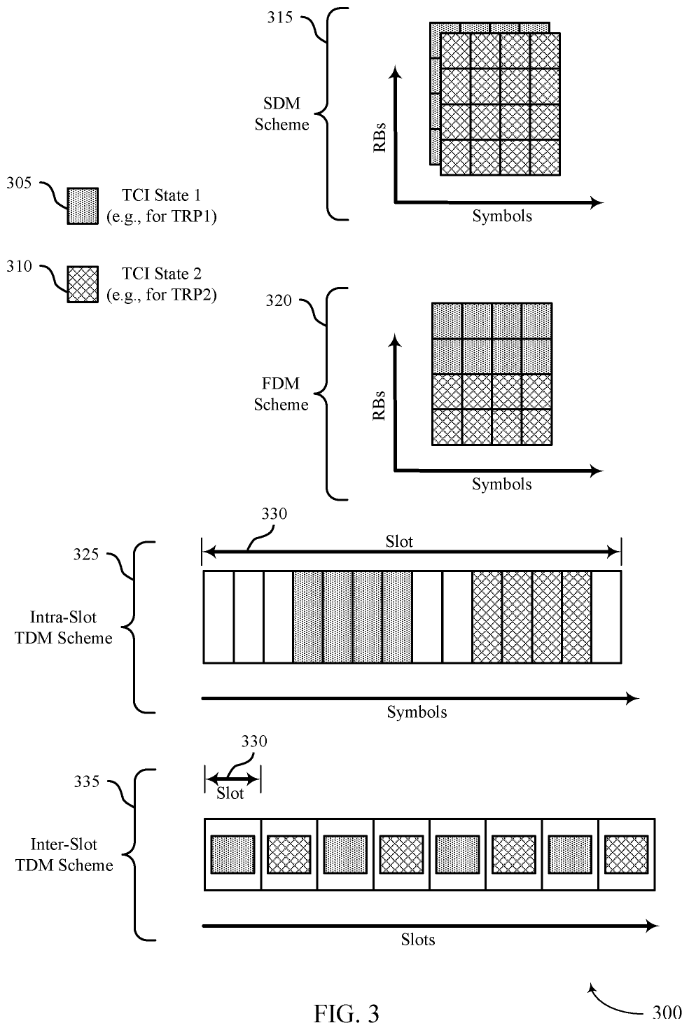

In some implementations, the UE 115-a may receive a configuration of TCI states from the base station 105-a, such as in a RRC message 210 via RRC signaling. The UE 115-a may receive a MAC-CE message 215 from the base station 105-a associated with the configuration of TCI states, where the MAC-CE message 215 may activate a subset of configured TCI states along with a mapping to TCI codepoints. In accordance with various aspects discussed herein, control information such as DCI 220 may indicate a particular TCI state codepoint, for use in communications with the base station 105-a, where the TCI codepoint indicates a particular TCI state or two or more particular TCI states from the subset of activated TCI states. In some cases, a scheduling DCI (e.g., a DCI subsequent to DCI 220, that provides a resource allocation for an uplink or downlink transmission) may indicate TCI state(s) for a communication based at least in part on one or more of a format of the control information (e.g., a DCI format), a payload field in the control information, a number of scheduled repetitions indicated in the control information, a control channel candidate or CORESET associated with the control information, a priority associated with a scheduled communication, or any combinations thereof. Various techniques discussed herein also may be applied to periodic communications (e.g., SPS communications or CG communications), where control information that activates communications (e.g., an activating DCI) may be used to indicate one or more TCI states. Various examples of TCI states, TCI state multiplexing, and signaling for one or more TCI states that are to be applied for certain communications, are discussed with reference to FIGS. 3 through 9.

FIG. 3 illustrates an example of multiplexing schemes 300 for TCI states in wireless communications in accordance with aspects of the present disclosure. The multiplexing schemes 300 may implement or be implemented by one or more aspects of the wireless communications systems 100 or 200. For example, the multiplexing schemes 300 may be utilized by one or more TRPs (e.g., base stations or TRPs associated with a base station), and a UE, which may be examples of corresponding devices as described with reference to FIGS. 1 and 2.

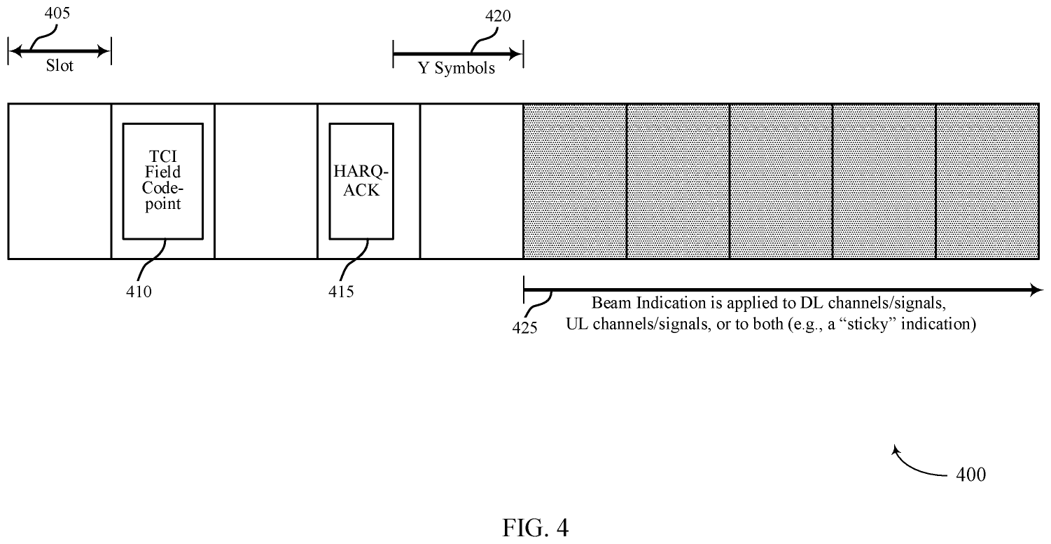

In the example of FIG. 3, a first TCI state 305 and a second TCI state 310 are illustrated. In some cases, the first TCI state 305 and the second TCI state 310 may be associated with a TCI codepoint that is provided to a UE (e.g., in a MAC-CE) and activated with an activation DCI, for use in subsequent communications with one or more TRPs. In some cases, one or more multiplexing schemes may be used. For example, a spatial division multiplexing (SDM) scheme 315 may be implemented, in which different spatial layers are associated with different TCI states. In some cases, a frequency division multiplexing (FDM) scheme 320 may be implemented, in which different frequency resources are associated with different TCI states. In other cases, time division multiplexing (TDM) may be implemented, such as an intra-slot TDM scheme 325 or an inter-slot TDM scheme 335 may have different time resources within a slot 330 or across slots 330 that are associated with different TCI states. As discussed herein, a MAC-CE may indicate TCI states based on a mapping between the one or two TCI states to TCI codepoints, and an activation DCI may activate one of the TCI codepoints. Further, a scheduling DCI may indicate one or two of the activated TCI states for a particular communication. If the indicated TCI codepoint is mapped to two TCI states, a communication with two TCI states (e.g., according to one of the multiplexing schemes of FIG. 3) is scheduled. An example of an activation DCI and TCI state application timing is discussed with reference to FIG. 4.

FIG. 4 illustrates an example of a TCI state timing 400 that in accordance with aspects of the present disclosure. The TCI state timing 400 may be implemented by one or more aspects of the wireless communications systems 100 or 200. For example, the TCI state timing 400 may be utilized by one or more TRPs (e.g., base stations or TRPs associated with a base station), and a UE, which may be examples of corresponding devices as described with reference to FIGS. 1 and 2.

In the example of FIG. 4, a UE and TRP may communicate in slots 405, in which one of the slots 405 may include an activation DCI that indicates a TCI field codepoint 410 (e.g., from two or more mapped TCI codepoints provided by a MAC-CE). As discussed herein, the TCI field codepoint 410 may be mapped to one or multiple TCI states (e.g., one or more uplink TCI states, one or more downlink TCI states, one or more joint DL/UL TCI states, or any combinations thereof). For example, one TCI field codepoint 410 may represent one or more joint downlink/uplink TCI state, which may be used for joint downlink/uplink beam indication. In another example, one TCI field codepoint 410 may represent one or more pairs with a downlink TCI state and uplink TCI state, which may be used for separate downlink/uplink beam indication. In other examples, one TCI field codepoint 410 may represent only one or more downlink TCI states, which may be used for downlink beam indication, or one TCI field codepoint 410 may represent only one or more uplink TCI states, which may be used for uplink beam indication. In some cases, if the MAC-CE indicates the mapping to only a single TCI field codepoint, it may serve as a beam indication, and a separate beam indication in an activation DCI may not be needed.

A UE that receives the DCI with the TCI field codepoint 410 may transmit a feedback indication, such as a HARQ-acknowledgment 415, to a base station or TRP that indicates successful receipt of the DCI. In some cases, the beam indication provided in the TCI field codepoint 410 may be applied to communications starting a predetermined time period 420 (e.g., Y symbols) after the HARQ-acknowledgment 415 (e.g., which may be an example of a determined time at which to apply the TCI state(s)). For example, the beam indication may be applied three milliseconds after HARQ-acknowledgment 415, as indicated at 425 in the example of FIG. 4. In some cases, the predetermined time period 420 may be applied in the first slot that is at least Y symbols (e.g., which is RRC-configured based on UE capability) after the last symbol of a control channel transmission (e.g., a physical uplink control channel (PUCCH) transmission) carrying the HARQ-acknowledgment 415. In some cases, the beam indication may be a “sticky” indications in that it is not related to the scheduled shared channel communication (e.g., a physical downlink shared channel (PDSCH) transmission), and it is not a one-time indication. When the beam indication is applied, it remains the same for the applicable channels/signals until changed (e.g., another MAC-CE or DCI format 1_1/1_2 changes the beam). In some cases, the beam indication may be common for multiple downlink channels/signals (e.g., PDSCH, PDCCH, CSI-RS) and/or multiple uplink channels/signals (PUSCH, PUCCH, SRS).

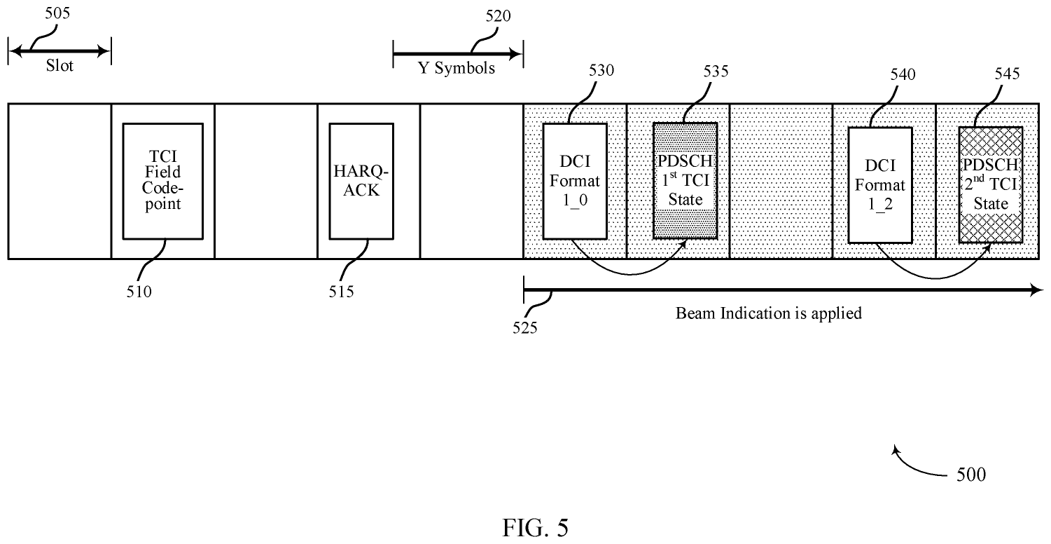

As discussed herein, in some cases, when two TCI states are applied to PDSCH/PUSCH/PUCCH transmissions starting after predetermined time period 420 (e.g., the first slot that is at least Y symbols after the last symbol of HARQ-acknowledgment 415), it may be desirable for a serving base station to schedule single-TRP (sTRP) operation with one TCI state among the two applied TCI states. For example, fallback DCI formats may not be able to schedule mTRP schemes (e.g., DCI format 1_0 for PDSCH scheduling and DCI format 0_0 for PUSCH scheduling). In addition, mTRP scheduling may not be needed all the time (e.g., eMBB traffic is being scheduled or when resources at both TRPs are not available). In some cases, a scheduling DCI may be used to indicate one or more selected TCI states of a pair of configured TCI states for an associated communication, examples of which are discussed with reference to FIGS. 5 through 9.

FIG. 5 illustrates an example of TCI state indications based on control information 500 in accordance with aspects of the present disclosure. The TCI state indications based on control information 500 may be implemented by one or more aspects of the wireless communications systems 100 or 200. For example, the TCI state indications based on control information 500 may be utilized by one or more TRPs (e.g., base stations or TRPs associated with a base station), and a UE, which may be examples of corresponding devices as described with reference to FIGS. 1 and 2.

In the example of FIG. 5, a base station or other network entity may transmit, and a UE may receive, a DCI with a TCI field codepoint 510, which may indicate a pair of TCI states for communications in slots 505 between the UE and base station. Similarly as discussed with reference to FIG. 4, the UE may transmit a HARQ-acknowledgment 515, and may apply the beam indication at 525, following predetermined time period 520 (e.g., Y symbols) after transmission of the HARQ-acknowledgment 515. In this example, when a pair of TCI states (e.g., DL/UL/both/joint) are indicated to be applied following the predetermined time period 520, a DCI format of a scheduling DCI may be used to distinguish whether both TCI states are applied for that scheduling instance or only one of them is applied for that scheduling instance. For example, a first scheduling DCI 530 may schedule a first PDSCH 535 and a second scheduling DCI 540 may schedule a second PDSCH 545, and a format of the scheduling DCIs 530, 540 may indicate one or more TCI states are to be applied. For example, DCI formats 0_0/1_0 may always schedule sTRP using a first applied TCI state of the pair of TCI states, while DCI formats 0_1/0_2/1_1/1_2 may schedule mTRP using both applied TCI states. In other cases, an association of a first DCI format with a first applied TCI state (e.g., for sTRP mode), or with a second applied TCI state (e.g., for sTRP mode), or with both applied TCI states (e.g., for mTRP mode) may RRC-configured (e.g., or MAC-CE activated) per scheduling DCI format. In some cases, the TCI states may apply to PDSCH/PUCCH/PUSCH scheduled by DCI formats (0_0/0_1/0_2 for PUSCH, and 1_0/1_1/1_2 for PDSCH/PUCCH).

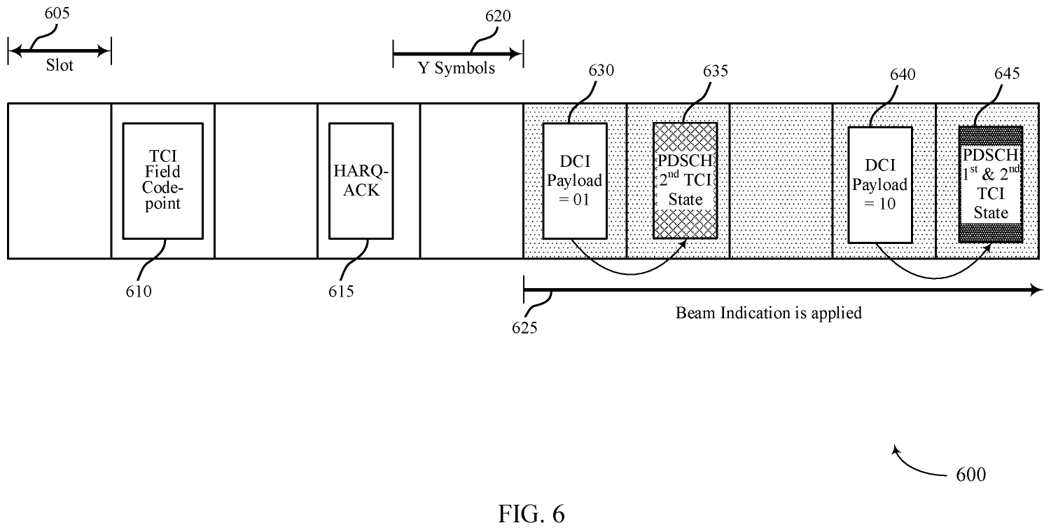

FIG. 6 illustrates another example of TCI state indications based on control information 600 in accordance with aspects of the present disclosure. The TCI state indications based on control information 600 may be implemented by one or more aspects of the wireless communications systems 100 or 200. For example, the TCI state indications based on control information 600 may be utilized by one or more TRPs (e.g., base stations or TRPs associated with a base station), and a UE, which may be examples of corresponding devices as described with reference to FIGS. 1 and 2.

In the example of FIG. 6, a base station or other network entity may transmit, and a UE may receive, a DCI with a TCI field codepoint 610, which may indicate a pair of TCI states for communications in slots 605 between the UE and base station. Similarly as discussed with reference to FIG. 4, the UE may transmit a HARQ-acknowledgment 615, and may apply the beam indication at 625, following predetermined time period 620 (e.g., Y symbols) after transmission of the HARQ-acknowledgment 615. In this example, when a pair of TCI states (e.g., DL/UL/both/joint) are indicated to be applied following the predetermined time period 620, a DCI payload of each scheduling DCI may be used to distinguish whether both TCI states are applied for that scheduling instance or only one of them is applied for that scheduling instance. For example, a first DCI payload 630 may indicate a second TCI state for a first PDSCH 635, and a second DCI payload 640 may indicate both a first and second TCI state for a second PDSCH 645.

In some cases, the DCI payload may be a single bit to indicate whether to use the first TCI state of the pair, or both TCI states. In other cases, such as illustrated in FIG. 6, two bits in the scheduling DCI payload may indicate whether to use the first TCI state of the pair, the second TCI state of the pair, or both TCI states. Further, in some cases, the DCI payload may indicate an order of applying the two TCI states to a scheduled PDSCH/PUCCH/PUSCH. The indicated TCI state(s) may be applied to communications (e.g., PDSCH/PUCCH/PUSCH) scheduled by that DCI. In some cases, for PUSCH, an existing field for dynamic switching (e.g., a SRS resource set indicator field) in DCI format 0_1/0_2 can be used for this purpose, a new field may be added, an existing field can be reused, or any combinations thereof.

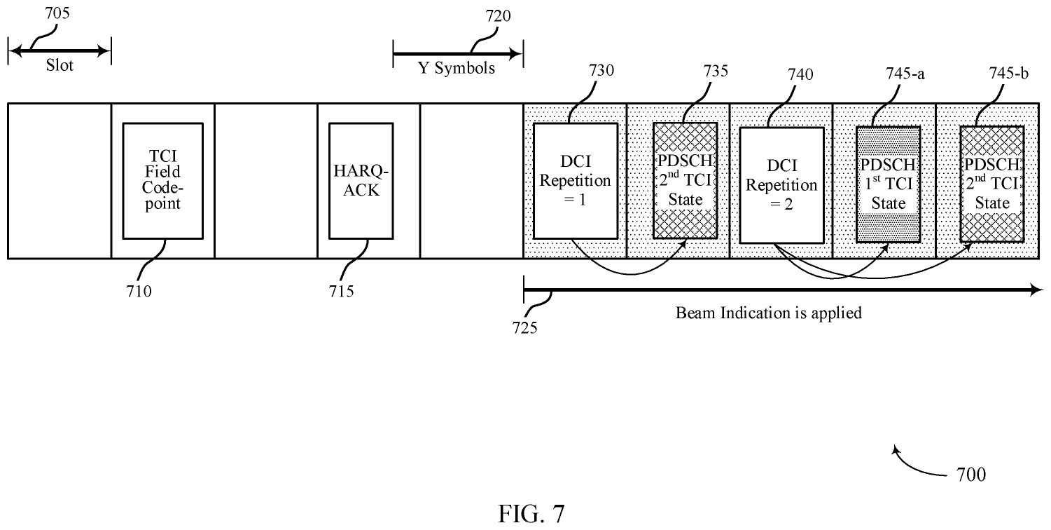

FIG. 7 illustrates an example of TCI state indications based on control information 500 in accordance with aspects of the present disclosure. The TCI state indications based on control information 700 may be implemented by one or more aspects of the wireless communications systems 100 or 200. For example, the TCI state indications based on control information 700 may be utilized by one or more TRPs (e.g., base stations or TRPs associated with a base station), and a UE, which may be examples of corresponding devices as described with reference to FIGS. 1 and 2.

In the example of FIG. 7, a base station or other network entity may transmit, and a UE may receive, a DCI with a TCI field codepoint 710, which may indicate a pair of TCI states for communications in slots 705 between the UE and base station. Similarly as discussed with reference to FIG. 4, the UE may transmit a HARQ-acknowledgment 715, and may apply the beam indication at 725, following predetermined time period 720 (e.g., Y symbols) after transmission of the HARQ-acknowledgment 715. In this example, when a pair of TCI states (e.g., DL/UL/both/joint) are indicated to be applied following the predetermined time period 720, a number of repetitions in the scheduling DCI may indicate whether both TCI states are applied for that scheduling instance or only one of them is applied for that scheduling instance. In this example, a first DCI 730 may indicate one repetition of a first PDSCH 735, and a second TCI state of the pair (or a first TCI state of the pair, based on configuration) is used. Otherwise, if multiple repetitions are indicated, both TCI states may be used in accordance with a configured multiplexing scheme. In the example of FIG. 7, a second DCI 740 may schedule two repetitions of PDSCH 745, and a TDM scheme may be configured, such that a first PDSCH repetition 745-a uses a first TCI state, and a second PDSCH repetition 745-b uses the second TCI state. Similarly, for PUCCH resources/formats that are RRC-configured with one repetition, the first TCI state of the beam indication may be used. In some cases, when PUCCH is scheduled by a DCI, a PUCCH resource indicator (PRI) field may determine the PUCCH resource and the number of repetitions associated with that PUCCH resource. In other cases, there may not be a scheduling DCI (e.g., PUCCH transmission is RRC-configured), and the corresponding PUCCH resource is based on RRC configuration, and a configured number of repetitions is used to determine the TCI state.

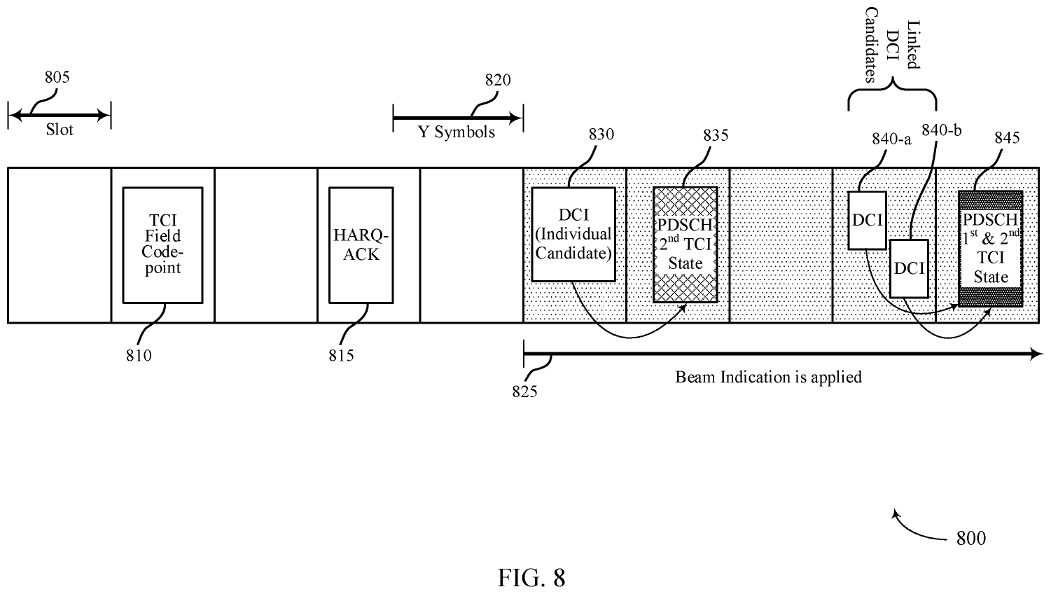

FIG. 8 illustrates an example of TCI state indications based on control information 800 in accordance with aspects of the present disclosure. The TCI state indications based on control information 800 may be implemented by one or more aspects of the wireless communications systems 100 or 200. For example, the TCI state indications based on control information 800 may be utilized by one or more TRPs (e.g., base stations or TRPs associated with a base station), and a UE, which may be examples of corresponding devices as described with reference to FIGS. 1 and 2.

In the example of FIG. 8, a base station or other network entity may transmit, and a UE may receive, a MAC-CE with a TCI field codepoint 810, which may indicate a pair of TCI states for communications in slots 805 between the UE and base station. Similarly as discussed with reference to FIG. 4, the UE may transmit a HARQ-acknowledgment 815, and may apply the beam indication at 825, following predetermined time period 820 (e.g., Y symbols) after transmission of the HARQ-acknowledgment 815. In this example, when a pair of TCI states (e.g., DL/UL/both/joint) are indicated to be applied following the predetermined time period 820, the PDCCH candidate(s) or CORESET(s) associated with each scheduling DCI may be used to distinguish whether both TCI states are applied for that scheduling instance or only one of them is applied for that scheduling instance. In the example of FIG. 8, a first DCI 830 may be decoded from an individual decoding candidate, and may indicate a first PDSCH 835 with only a second TCI state or only a first TCI state. Further, a second DCI may be decoded from a set of linked PDCCH candidates 840-a and 840-b, which may indicate that a second PDSCH 845 is transmitted with both first and second TCI states.

In some cases, the TCI states of linked PDCCH candidates may be further conditioned on linked PDCCH candidates being associated with different TCI states. In some cases, if an individual decoding candidate is used to convey the DCI, one TCI state of the pair is used (e.g., the second TCI state or the first TCI state). In other cases, whether the first or second TCI state of the pair is used depends on the associated scheduling CORESET. For example, whether the CORESET in which the scheduling DCI is detected is associated a first TCI state or a second TCI state of a TCI state pair (e.g., which may or may not be the same as the TCI pair indicated by the TCI field codepoint 810). If the scheduling DCI is detected in a CORESET associated with two TCI states (e.g., a single frequency network (SFN) transmitted CORESET), both TCI states of the pair are used (e.g., where the two TCI states of the SFNed CORESET may or may not be the same as the pair of TCI states indicated by the TCI field codepoint 810). In some cases, the indicated TCI state(s) apply to PDSCH/PUCCH/PUSCH scheduled by the DCI.

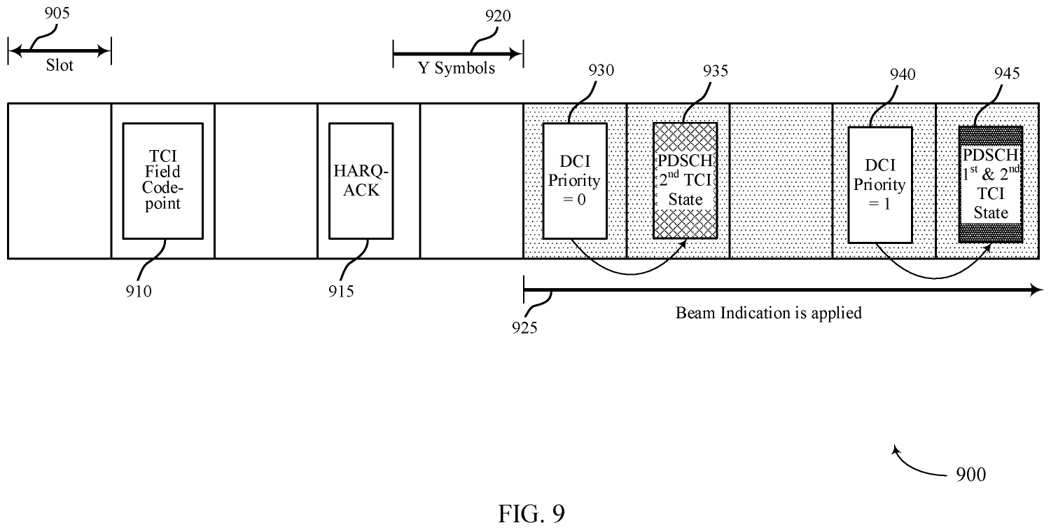

FIG. 9 illustrates an example of a TCI state indications based on control information 900 in accordance with aspects of the present disclosure. The TCI state indications based on control information 900 may be implemented by one or more aspects of the wireless communications systems 100 or 200. For example, the TCI state indications based on control information 900 may be utilized by one or more TRPs (e.g., base stations or TRPs associated with a base station), and a UE, which may be examples of corresponding devices as described with reference to FIGS. 1 and 2.

In the example of FIG. 9, a base station or other network entity may transmit, and a UE may receive, a DCI with a TCI field codepoint 910, which may indicate a pair of TCI states for communications in slots 905 between the UE and base station. Similarly as discussed with reference to FIG. 4, the UE may transmit a HARQ-acknowledgment 915, and may apply the beam indication at 925, following predetermined time period 920 (e.g., Y symbols) after transmission of the HARQ-acknowledgment 915. In this example, when a pair of TCI states (e.g., DL/UL/both/joint) are indicated to be applied following the predetermined time period 920, a priority associated with the scheduled channel (e.g., which is indicated by or associated with the scheduling DCI) may be used to distinguish whether both TCI states are applied for that scheduling instance or only one of them is applied for that scheduling instance. For example, if a first DCI 930 indicates priority zero is associated with a first PDSCH 935, a second TCI state (or first TCI state) of the pair of TCI states is used, and if a second DCI 940 indicates priority one is associated with a second PDSCH 945, both TCI states are used. In some cases, the indicated TCI state(s) apply to PDSCH/PUCCH/PUSCH scheduled by the DCI. In some cases, the priority may be indicated by the scheduling DCI through a “Priority indicator” field. In other cases, priority may not be indicated by the DCI, and a priority zero may be assumed. In some cases, the TCI state(s) may be applied to SPS PDSCH, SPS HARQ-Ack, and CG-PUSCH, where the priority may be RRC-configured per SPS-configuration or per CG configuration.

While the examples of FIGS. 4 through 9 illustrate scheduling DCIs, the techniques as discussed herein also apply to periodic communications that may be configured between a UE and one or more TRPs. For example, for SPS PDSCH, HARQ-Ack corresponding to SPS PDSCH transmitted on PUCCH, CG-PUSCH, and SP-CSI on PUSCH, the techniques as discussed herein may be used, where instead of the property to determine the TCI state being associated with scheduling DCI, the property to determine the TCI state is associated with an activating DCI. In such cases, the activating DCI activates the PDSCH/PUCCH/PUSCH and the transmissions occur periodically until another DCI deactivates the transmissions. Additionally, techniques as discussed herein may be applied to any of the TDM (inter-slot or intra-slot)/FDM/SDM/SFN multiplexing schemes discussed herein. Further, the techniques discussed herein may also be applicable in cases where the control information is provided in the MAC-CE based beam indication when the MAC-CE indicates the mapping to only a single TCI field codepoint (e.g., mapped to a pair of TCI states with one uplink TCI state and one downlink TCI state).

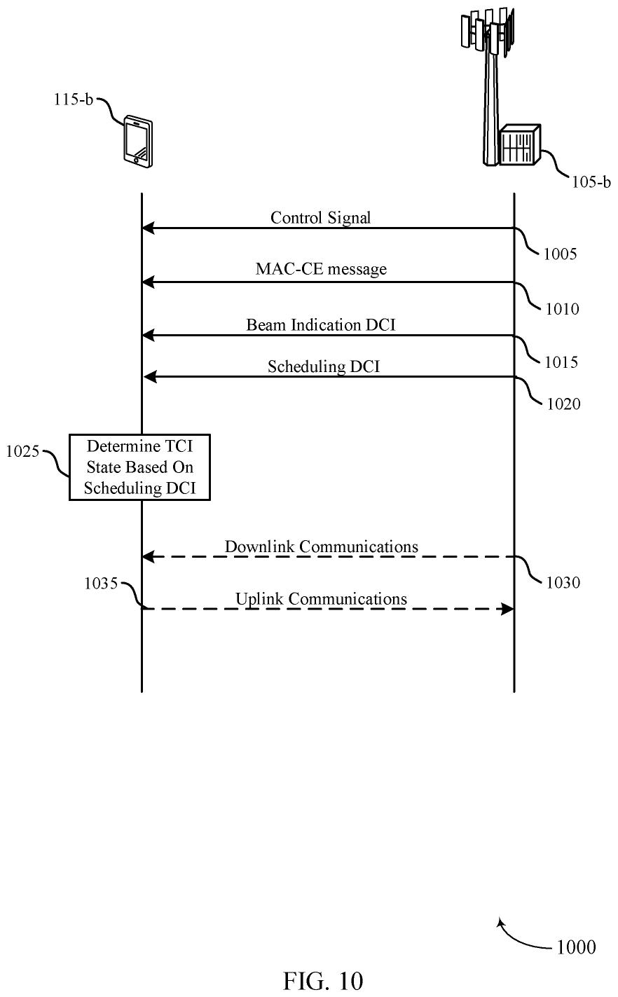

FIG. 10 illustrates an example of a process flow 1000 that supports transmission configuration indicator state identification in wireless communications in accordance with aspects of the present disclosure. The process flow may be implemented by devices in a wireless communications system as discussed herein. For example, the process flow 1000 may include a UE 115-b and a base station 105-b, which may be examples of UEs 115 and base stations 105 as discussed with reference to FIGS. 1 and 2. In the following description of the process flow 1000, operations between the UE 115-b and the base station 105-b, may occur in a different order or at different times than as shown. Some operations also may be omitted from the process flow 1000, and other operations may be added to the process flow 1000, such as multiple TRPs in addition to the base station 105-b.

At 1005, the base station 105-b may transmit a control signal to the UE 115-b. For example, the base station 105-b may transmit an RRC message to the UE 115-b indicating a set of available beam configurations TCI states, or multiple lists of beam configurations. In some implementations, beam configurations may refer to TCI states. Beam configurations may refer to one or more configurations or settings for transmitting uplink signaling, receiving downlink signaling, or both, such as TCI states. At 1010, the base station 105-b may transmit a MAC-CE message to the UE 115-b indicating which TCI states, as indicated by the control signal (e.g., RRC message) at 1005, are activated. In some implementations, the MAC-CE message may indicate joint TCI states, single TCI states, or both.

At 1015, the base station 105-b may transmit a beam indication DCI to the UE 115-b. In some cases, the beam indication DCI may indicate which TCI state(s) (e.g., in a TCI field codepoint) are associated with one or more communications instances the UE 115-b may utilize to communicate with the base station 105-b, such as discussed with reference to the examples of FIGS. 4 through 9. At 1020, the base station 105-b may transmit a scheduling DCI to the UE 115-b, which may indicate allocated resources for one or more uplink or downlink communications.

At 1025, the UE 115-b may determine one or more TCI state(s) for communications based on the scheduling DCI, such as discussed with reference to the examples of FIGS. 5 through 9. In such implementations, the UE 115-b may utilize an uplink TCI state and a downlink TCI state to perform uplink and downlink communications with the base station 105-b. In some implementations, the DCI may activate an uplink TCI state for uplink communications, or a downlink TCI state for downlink communications, or both.

Optionally, at 1030, associated with the determination of the TCI state, the UE 115-b may perform downlink communications with the base station 105-b. Optionally, at 1035, associated with the determination of the TCI state, the UE 115-b may perform uplink communications with the base station 105-b. In cases where the TCI state indicates two TCI states for uplink or downlink (or both), the communications may be mTRP communications in accordance with a multiplexing scheme, as discussed herein.

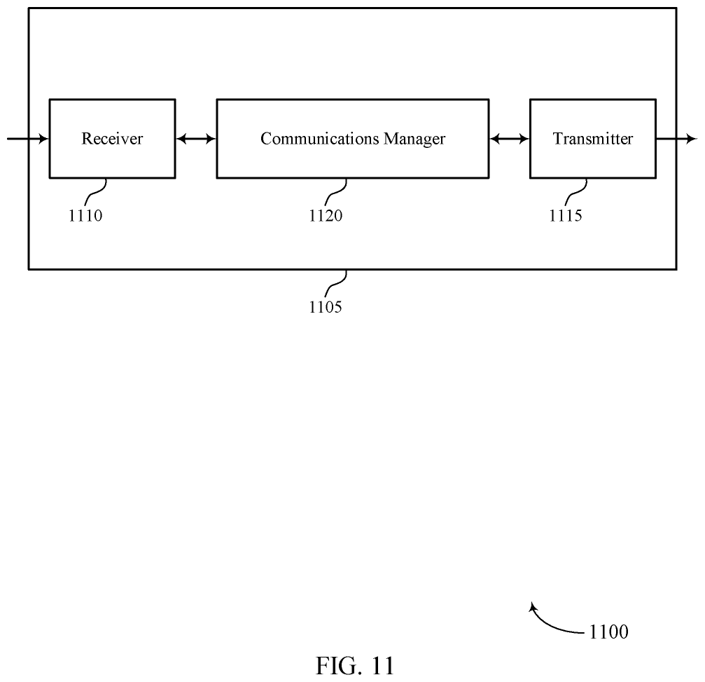

FIG. 11 shows a block diagram 1100 of a device 1105 that supports transmission configuration indicator state identification in wireless communications in accordance with aspects of the present disclosure. The device 1105 may be an example of aspects of a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to transmission configuration indicator state identification in wireless communications). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to transmission configuration indicator state identification in wireless communications). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of transmission configuration indicator state identification in wireless communications as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software) executed by a processor. If implemented in code executed by a processor, the functions of the communications manager 1120, the receiver 1110, the transmitter 1115, or various combinations or components thereof may be performed by a general-purpose processor, a DSP, a central processing unit (CPU), a graphics processing unit (GPU), an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a UE in accordance with examples as disclosed herein. For example, the communications manager 1120 may be configured as or otherwise support a means for receiving, from a network entity, control signaling identifying two or more transmission configuration indicator states that are to be applied to communications of one or more channels subsequent to a determined time. The communications manager 1120 may be configured as or otherwise support a means for receiving, from the network entity, control information associated with one or more resource allocations for communications after the determined time. The communications manager 1120 may be configured as or otherwise support a means for communicating via the one or more channels according to a first transmission configuration indicator state of the two or more transmission configuration indicator states based on a parameter associated with the control information and the two or more transmission configuration indicator states.

By including or configuring the communications manager 1120 in accordance with examples as described herein, the device 1105 (e.g., a processor controlling or otherwise coupled to the receiver 1110, the transmitter 1115, the communications manager 1120, or a combination thereof) may support techniques for selection of one or more particular TCI states for a one or more communications where multiple TCI states are configured, which may provide for reduced signaling overhead, increased flexibility, more efficient use of spatial resources, decreased collisions and interference, increased reliability of communications, and improved user experience.

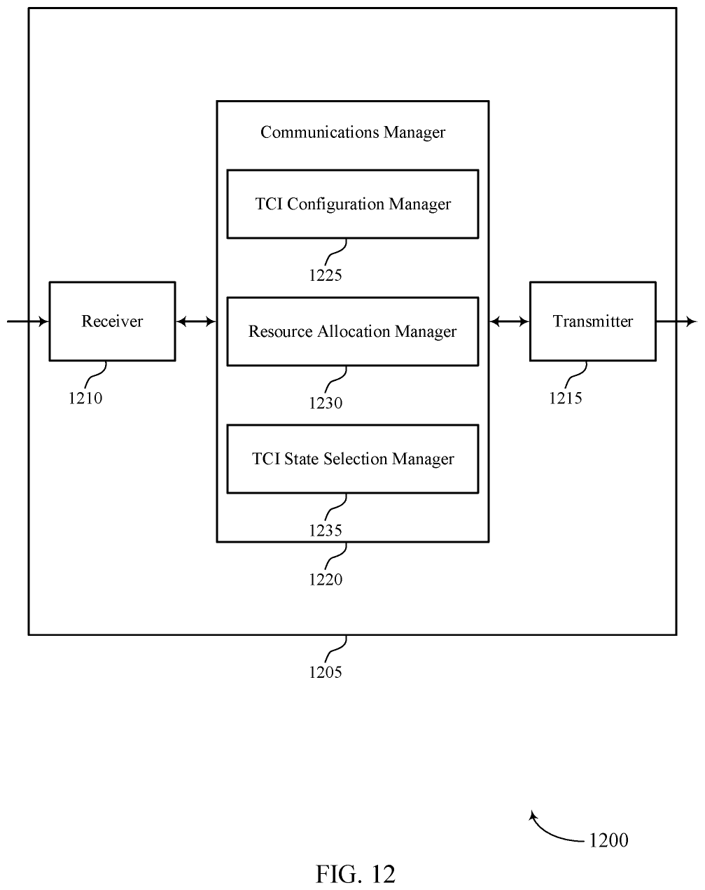

FIG. 12 shows a block diagram 1200 of a device 1205 that supports transmission configuration indicator state identification in wireless communications in accordance with aspects of the present disclosure. The device 1205 may be an example of aspects of a device 1105 or a UE 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to transmission configuration indicator state identification in wireless communications). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to transmission configuration indicator state identification in wireless communications). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of transmission configuration indicator state identification in wireless communications as described herein. For example, the communications manager 1220 may include a TCI configuration manager 1225, a resource allocation manager 1230, a TCI state selection manager 1235, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a UE in accordance with examples as disclosed herein. The TCI configuration manager 1225 may be configured as or otherwise support a means for receiving, from a network entity, control signaling identifying two or more transmission configuration indicator states that are to be applied to communications of one or more channels subsequent to a determined time. The resource allocation manager 1230 may be configured as or otherwise support a means for receiving, from the network entity, control information associated with one or more resource allocations for communications after the determined time. The TCI state selection manager 1235 may be configured as or otherwise support a means for communicating via the one or more channels according to a first transmission configuration indicator state of the two or more transmission configuration indicator states based on a parameter associated with the control information and the two or more transmission configuration indicator states.

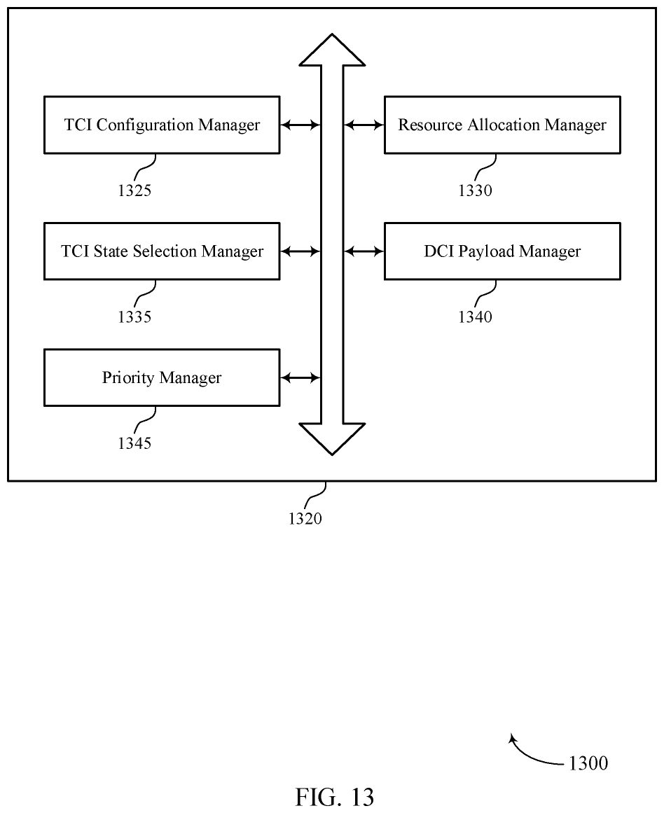

FIG. 13 shows a block diagram 1300 of a communications manager 1320 that supports transmission configuration indicator state identification in wireless communications in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of transmission configuration indicator state identification in wireless communications as described herein. For example, the communications manager 1320 may include a TCI configuration manager 1325, a resource allocation manager 1330, a TCI state selection manager 1335, a DCI payload manager 1340, a priority manager 1345, or any combination thereof. Each of these components may communicate, directly or indirectly, with one another (e.g., via one or more buses).

The communications manager 1320 may support wireless communication at a UE in accordance with examples as disclosed herein. The TCI configuration manager 1325 may be configured as or otherwise support a means for receiving, from a network entity, control signaling identifying two or more transmission configuration indicator states that are to be applied to communications of one or more channels subsequent to a determined time. The resource allocation manager 1330 may be configured as or otherwise support a means for receiving, from the network entity, control information associated with one or more resource allocations for communications after the determined time. The TCI state selection manager 1335 may be configured as or otherwise support a means for communicating via the one or more channels according to a first transmission configuration indicator state of the two or more transmission configuration indicator states based on a parameter associated with the control information and the two or more transmission configuration indicator states. In some examples, the two or more transmission configuration indicator states provide for multi-transmission reception point communications with two or more transmission reception points associated with the network entity.

In some examples, to support receiving the control information, the resource allocation manager 1330 may be configured as or otherwise support a means for receiving DCI having a first DCI format that indicates the first transmission configuration indicator state for at least a first communication via the one or more channels, and where a second DCI format is associated with both the first transmission configuration indicator state and a second transmission configuration indicator state for communications via the one or more channels. In some examples, the first DCI format is associated with a first subset of DCI formats that schedule single transmission reception point communications using the first transmission configuration indicator state, and the second DCI format is associated with a second subset of DCI formats that schedule multi-transmission reception point communications using both the first transmission configuration indicator state and the second transmission configuration indicator state.

In some examples, the TCI state selection manager 1335 may be configured as or otherwise support a means for receiving configuration information that maps the first DCI format to the first transmission configuration indicator state, and that maps the second DCI format to both the first transmission configuration indicator state and the second transmission configuration indicator state. In some examples, the first transmission configuration indicator state applies to PDSCH communications, PUCCH communications, PUSCH communications, or any combinations thereof, that are scheduled by the first DCI format. In some examples, both the first transmission configuration indicator state and the second transmission configuration indicator state apply to PDSCH communications, PUCCH communications, PUSCH communications, or any combinations thereof, that are scheduled by the second DCI format.

In some examples, to support receiving the control information, the DCI payload manager 1340 may be configured as or otherwise support a means for receiving DCI having a DCI payload that indicates the first transmission configuration indicator state for at least a first communication via the one or more channels, or that indicates both the first transmission configuration indicator state and a second transmission configuration indicator state for communications via the one or more channels. In some examples, the DCI payload is a one-bit field that indicates to use the first transmission configuration indicator state or to use both the first transmission configuration indicator state and the second transmission configuration indicator state. In some examples, the DCI payload is a two-bit field that indicates to use the first transmission configuration indicator state, to use the second transmission configuration indicator state for communications with a second transmission reception point, or to use both the first transmission configuration indicator state and the second transmission configuration indicator state. In some examples, the two-bit field further indicates an order for applying the first transmission configuration indicator state and the second transmission configuration indicator state to a first resource allocation of a first channel of the one or more channels and a second resource allocation of a second channel of the one or more channels.

In some examples, to support receiving the control information, the resource allocation manager 1330 may be configured as or otherwise support a means for receiving an indication of a number of repetitions of each communication are to be provided in the one or more resource allocations, and where first number of repetitions indicates the first transmission configuration indicator state for at least a first communication via the one or more channels, and a second number of repetitions indicates both the first transmission configuration indicator state and a second transmission configuration indicator state for communications via the one or more channels. In some examples, the first transmission configuration indicator state used when the number of repetitions is a single repetition, and both the first transmission configuration indicator state and the second transmission configuration indicator state are used when the number of repetitions is two or more repetitions.

In some examples, the TCI state selection manager 1335 may be configured as or otherwise support a means for identifying a control channel decoding candidate or a control resource set that is associated with the control information, and where a first subset of control channel decoding candidates or a first subset of control resource sets are associated with the first transmission configuration indicator state for communications via the one or more channels, and a second subset of control channel decoding candidates or a second subset of control resource sets are associated with both the first transmission configuration indicator state and a second transmission configuration indicator state for communications via the one or more channels. In some examples, the first transmission configuration indicator state is associated with a single control channel decoding candidate, and both the first transmission configuration indicator state and the second transmission configuration indicator state are associated with multiple control channel decoding candidates for the control information, where the multiple control channel decoding candidates are linked for control information repetition across the multiple control channel decoding candidates. In some examples, the first subset of control resource sets is associated with a single transmission configuration indicator state, and the second subset of control resource sets is associated with multiple transmission configuration indicator states.

In some examples, to support receiving the control information, the priority manager 1345 may be configured as or otherwise support a means for receiving, with the control information, an indication of a priority of one or more associated communications, and where first priority indicates the first transmission configuration indicator state for at least a first communication with a first transmission reception point, and a second priority indicates both the first transmission configuration indicator state and a second transmission configuration indicator state for communications with two or more transmission reception points. In some examples, the control information is a scheduling downlink control indication (DCI) that indicates allocated resources for communications, or is an activation DCI that activates communication using previously configured resources. In some examples, the two or more transmission configuration indicator states are associated with multi-transmission reception point communications with two or more transmission reception points according to a time division multiplexing communications scheme, a frequency division multiplexing communications scheme, a spatial division multiplexing communications scheme, or a single frequency network communications scheme. In some examples, the one or more channels include a downlink shared channel, uplink shared channel, uplink control channel, or any combinations thereof, and where. In some examples, the control signaling includes one or more of downlink control information having a first format with a transmission configuration indicator state field, or a medium access control (MAC) control element that indicates a single transmission configuration indicator codepoint that is mapped to the two or more transmission configuration indicator states.

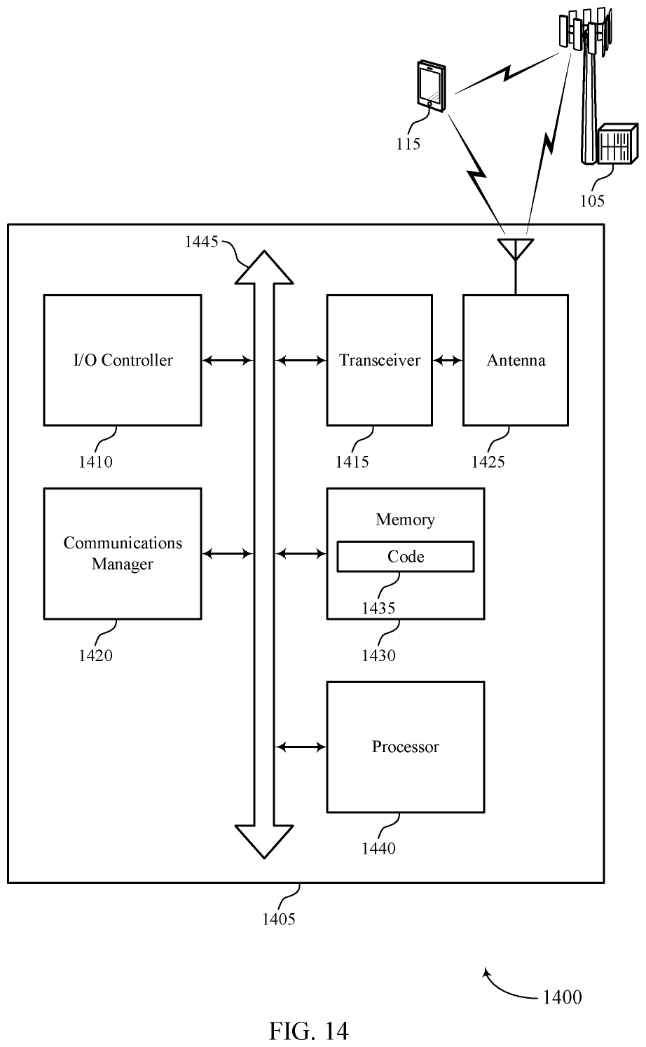

FIG. 14 shows a diagram of a system 1400 including a device 1405 that supports transmission configuration indicator state identification in wireless communications in accordance with aspects of the present disclosure. The device 1405 may be an example of or include the components of a device 1105, a device 1205, or a UE 115 as described herein. The device 1405 may communicate wirelessly with one or more base stations 105, UEs 115, or any combination thereof. The device 1405 may include components for bi-directional voice and data communications including components for transmitting and receiving communications, such as a communications manager 1420, an input/output (I/O) controller 1410, a transceiver 1415, an antenna 1425, a memory 1430, code 1435, and a processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally or alternatively, the I/O controller 1410 may represent or interact with a modem, a keyboard, a mouse, a touchscreen, or a similar device. In some cases, the I/O controller 1410 may be implemented as part of a processor, such as the processor 1440. In some cases, a user may interact with the device 1405 via the I/O controller 1410 or via hardware components controlled by the I/O controller 1410.

In some cases, the device 1405 may include a single antenna 1425. However, in some other cases, the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include random access memory (RAM) and read-only memory (ROM). The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a basic I/O system (BIOS) which may control basic hardware or software operation such as the interaction with peripheral components or devices.

The processor 1440 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting transmission configuration indicator state identification in wireless communications). For example, the device 1405 or a component of the device 1405 may include a processor 1440 and memory 1430 coupled with or to the processor 1440, the processor 1440 and memory 1430 configured to perform various functions described herein.

The communications manager 1420 may support wireless communication at a UE in accordance with examples as disclosed herein. For example, the communications manager 1420 may be configured as or otherwise support a means for receiving, from a network entity, control signaling identifying two or more transmission configuration indicator states that are to be applied to communications of one or more channels subsequent to a determined time. The communications manager 1420 may be configured as or otherwise support a means for receiving, from the network entity, control information associated with one or more resource allocations for communications after the determined time. The communications manager 1420 may be configured as or otherwise support a means for communicating via the one or more channels according to a first transmission configuration indicator state of the two or more transmission configuration indicator states based on a parameter associated with the control information and the two or more transmission configuration indicator states.

By including or configuring the communications manager 1420 in accordance with examples as described herein, the device 1405 may support techniques for selection of one or more particular TCI states for a one or more communications where multiple TCI states are configured, which may provide for reduced signaling overhead, increased flexibility, more efficient use of spatial resources, decreased collisions and interference, increased reliability of communications, and improved user experience.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of transmission configuration indicator state identification in wireless communications as described herein, or the processor 1440 and the memory 1430 may be otherwise configured to perform or support such operations.

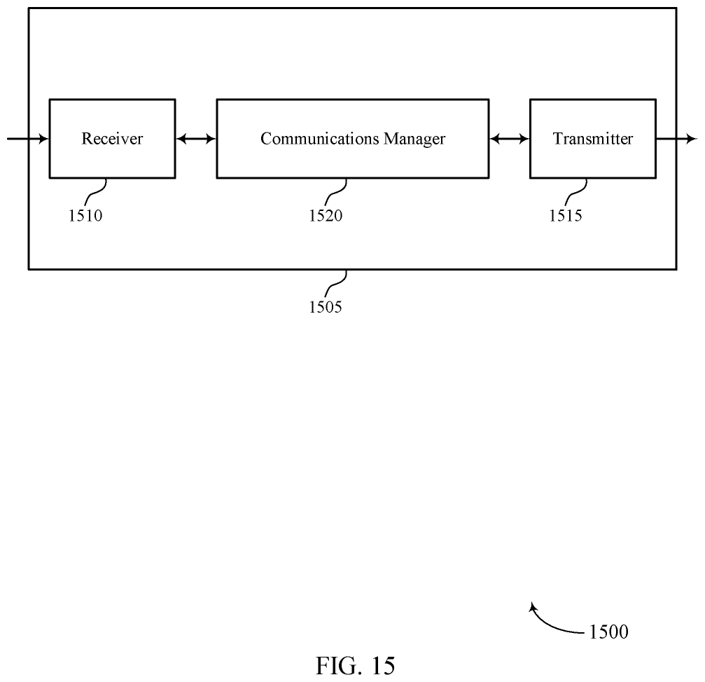

FIG. 15 shows a block diagram 1500 of a device 1505 that supports transmission configuration indicator state identification in wireless communications in accordance with aspects of the present disclosure. The device 1505 may be an example of aspects of a base station 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for receiving information such as packets, user data, control information, or any combination thereof associated with various information channels (e.g., control channels, data channels, information channels related to transmission configuration indicator state identification in wireless communications). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to transmission configuration indicator state identification in wireless communications). In some examples, the transmitter 1515 may be co-located with a receiver 1510 in a transceiver module. The transmitter 1515 may utilize a single antenna or a set of multiple antennas.

The communications manager 1520, the receiver 1510, the transmitter 1515, or various combinations thereof or various components thereof may be examples of means for performing various aspects of transmission configuration indicator state identification in wireless communications as described herein. For example, the communications manager 1520, the receiver 1510, the transmitter 1515, or various combinations or components thereof may support a method for performing one or more of the functions described herein.

In some examples, the communications manager 1520, the receiver 1510, the transmitter 1515, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1520, the receiver 1510, the transmitter 1515, or various combinations or components thereof may be implemented in code (e.g., as communications management software) executed by a processor. If implemented in code executed by a processor, the functions of the communications manager 1520, the receiver 1510, the transmitter 1515, or various combinations or components thereof may be performed by a general-purpose processor, a DSP, a CPU, a GPU, an ASIC, an FPGA, or any combination of these or other programmable logic devices (e.g., configured as or otherwise supporting a means for performing the functions described in the present disclosure).

In some examples, the communications manager 1520 may be configured to perform various operations (e.g., receiving, monitoring, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to receive information, transmit information, or perform various other operations as described herein.

The communications manager 1520 may support wireless communication at a network entity in accordance with examples as disclosed herein. For example, the communications manager 1520 may be configured as or otherwise support a means for transmitting, to a UE, control signaling identifying two or more transmission configuration indicator states that are to be applied to communications of one or more channels subsequent to a determined time. The communications manager 1520 may be configured as or otherwise support a means for transmitting, to the UE, control information associated with one or more resource allocations for communications after the determined time. The communications manager 1520 may be configured as or otherwise support a means for communicating with the UE via the one or more channels according to a first transmission configuration indicator state of the two or more transmission configuration indicator states based on a parameter associated with the control information and the two or more transmission configuration indicator states.

By including or configuring the communications manager 1520 in accordance with examples as described herein, the device 1505 (e.g., a processor controlling or otherwise coupled to the receiver 1510, the transmitter 1515, the communications manager 1520, or a combination thereof) may support techniques for selection of one or more particular TCI states for a one or more communications where multiple TCI states are configured, which may provide for reduced signaling overhead, increased flexibility, more efficient use of spatial resources, decreased collisions and interference, increased reliability of communications, and improved user experience.

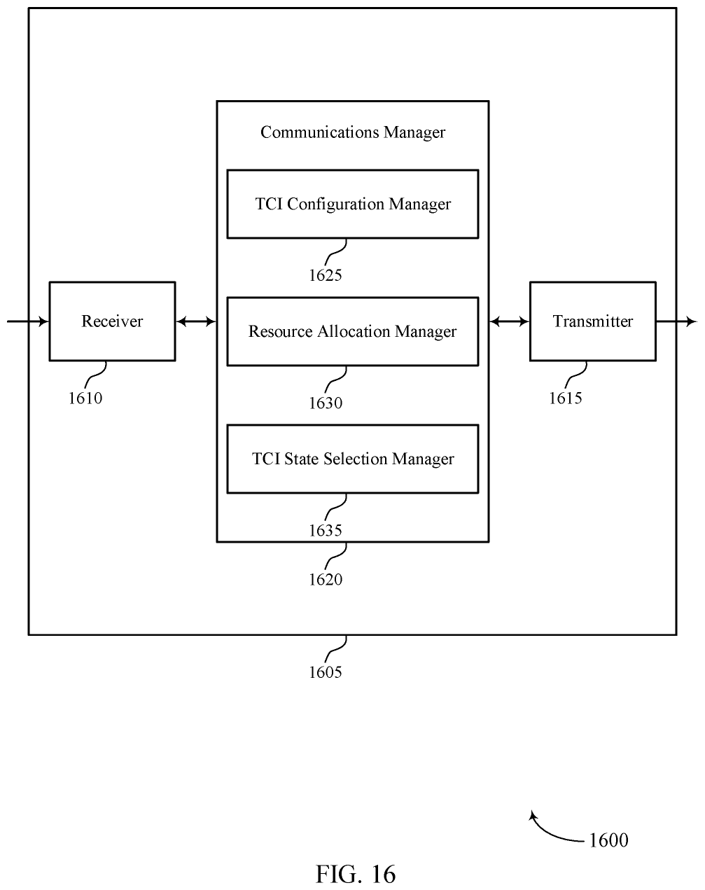

FIG. 16 shows a block diagram 1600 of a device 1605 that supports transmission configuration indicator state identification in wireless communications in accordance with aspects of the present disclosure. The device 1605 may be an example of aspects of a device 1505 or a base station 105 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for receiving information such as packets, user data, control information, or any combination thereof associated with various information channels (e.g., control channels, data channels, information channels related to transmission configuration indicator state identification in wireless communications). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to transmission configuration indicator state identification in wireless communications). In some examples, the transmitter 1615 may be co-located with a receiver 1610 in a transceiver module. The transmitter 1615 may utilize a single antenna or a set of multiple antennas.

The device 1605, or various components thereof, may be an example of means for performing various aspects of transmission configuration indicator state identification in wireless communications as described herein. For example, the communications manager 1620 may include a TCI configuration manager 1625, a resource allocation manager 1630, a TCI state selection manager 1635, or any combination thereof. The communications manager 1620 may be an example of aspects of a communications manager 1520 as described herein. In some examples, the communications manager 1620, or various components thereof, may be configured to perform various operations (e.g., receiving, monitoring, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to receive information, transmit information, or perform various other operations as described herein.

The communications manager 1620 may support wireless communication at a network entity in accordance with examples as disclosed herein. The TCI configuration manager 1625 may be configured as or otherwise support a means for transmitting, to a UE, control signaling identifying two or more transmission configuration indicator states that are to be applied to communications of one or more channels subsequent to a determined time. The resource allocation manager 1630 may be configured as or otherwise support a means for transmitting, to the UE, control information associated with one or more resource allocations for communications after the determined time. The TCI state selection manager 1635 may be configured as or otherwise support a means for communicating with the UE via the one or more channels according to a first transmission configuration indicator state of the two or more transmission configuration indicator states based on a parameter associated with the control information and the two or more transmission configuration indicator states.

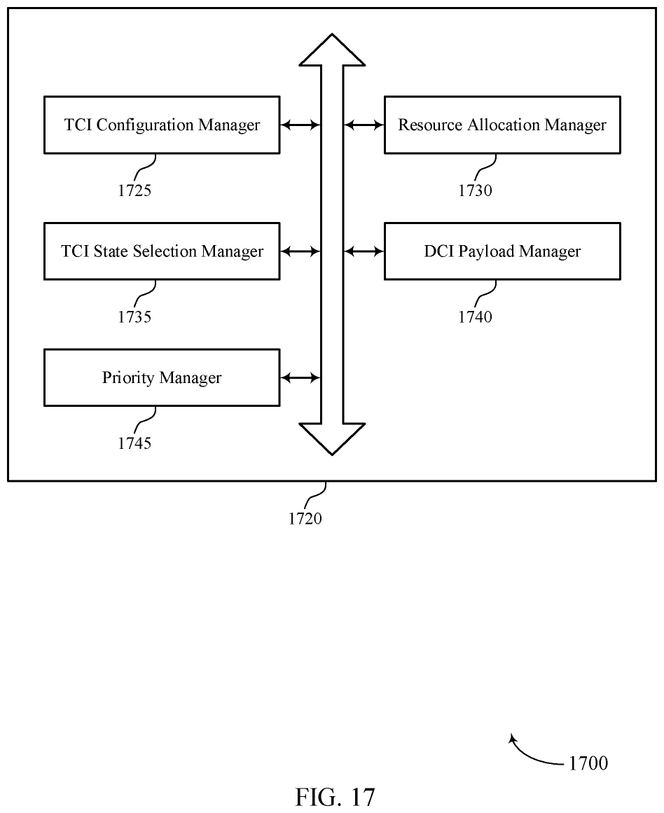

FIG. 17 shows a block diagram 1700 of a communications manager 1720 that supports transmission configuration indicator state identification in wireless communications in accordance with aspects of the present disclosure. The communications manager 1720 may be an example of aspects of a communications manager 1520, a communications manager 1620, or both, as described herein. The communications manager 1720, or various components thereof, may be an example of means for performing various aspects of transmission configuration indicator state identification in wireless communications as described herein. For example, the communications manager 1720 may include a TCI configuration manager 1725, a resource allocation manager 1730, a TCI state selection manager 1735, a DCI payload manager 1740, a priority manager 1745, or any combination thereof. Each of these components may communicate, directly or indirectly, with one another (e.g., via one or more buses).

The communications manager 1720 may support wireless communication at a network entity in accordance with examples as disclosed herein. The TCI configuration manager 1725 may be configured as or otherwise support a means for transmitting, to a UE, control signaling identifying two or more transmission configuration indicator states that are to be applied to communications of one or more channels subsequent to a determined time. The resource allocation manager 1730 may be configured as or otherwise support a means for transmitting, to the UE, control information associated with one or more resource allocations for communications after the determined time. The TCI state selection manager 1735 may be configured as or otherwise support a means for communicating with the UE via the one or more channels according to a first transmission configuration indicator state of the two or more transmission configuration indicator states based on a parameter associated with the control information and the two or more transmission configuration indicator states.

In some examples, to support transmitting the control information, the TCI state selection manager 1735 may be configured as or otherwise support a means for transmitting DCI having a first DCI format that indicates the first transmission configuration indicator state for at least a first communication via the one or more channels, and where a second DCI format is associated with both the first transmission configuration indicator state and a second transmission configuration indicator state for communications via the one or more channels.

In some examples, to support transmitting the control information, the DCI payload manager 1740 may be configured as or otherwise support a means for transmitting DCI having a DCI payload that indicates the first transmission configuration indicator state for at least a first communication via the one or more channels, or that indicates both the first transmission configuration indicator state and a second transmission configuration indicator state for communications via the one or more channels.

In some examples, to support transmitting the control information, the resource allocation manager 1730 may be configured as or otherwise support a means for transmitting an indication of a number of repetitions of each communication are to be provided in the one or more resource allocations, and where first number of repetitions indicates the first transmission configuration indicator state for at least a first communication via the one or more channels, and a second number of repetitions indicates both the first transmission configuration indicator state and a second transmission configuration indicator state for communications via the one or more channels. In some examples, a first subset of control channel decoding candidates or a first subset of control resource sets used for providing the control information are associated with the first transmission configuration indicator state for communications via the one or more channels, and a second subset of control channel decoding candidates or a second subset of control resource sets are associated with both the first transmission configuration indicator state and a second transmission configuration indicator state for communications via the one or more channels.

In some examples, to support transmitting the control information, the priority manager 1745 may be configured as or otherwise support a means for transmitting, with the control information, an indication of a priority of one or more associated communications, and where first priority indicates the first transmission configuration indicator state for at least a first communication via the one or more channels, and a second priority indicates both the first transmission configuration indicator state and a second transmission configuration indicator state for communications via the one or more channels.

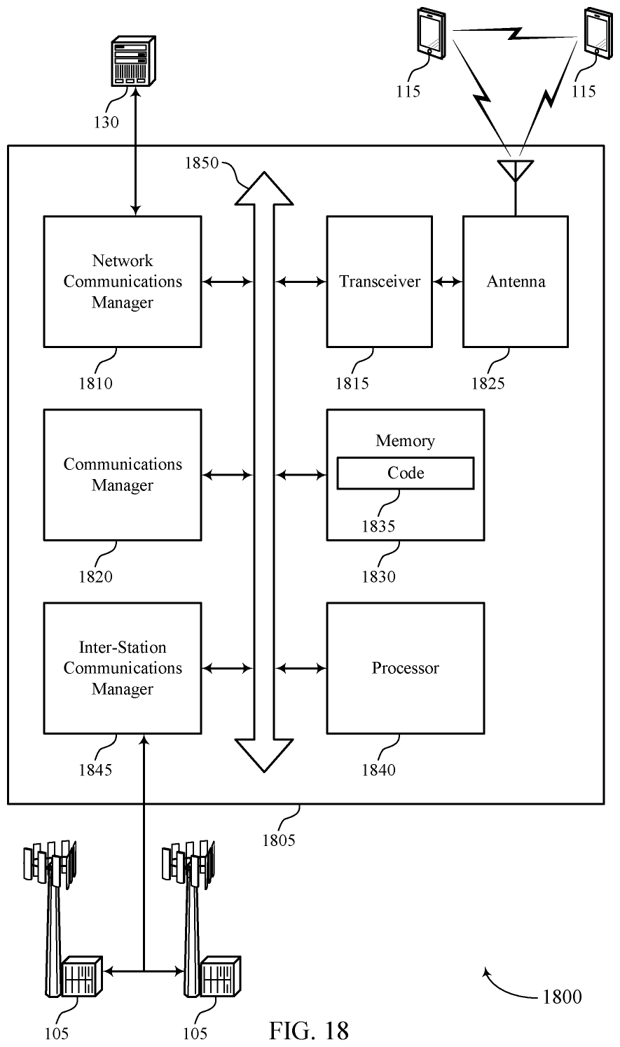

FIG. 18 shows a diagram of a system 1800 including a device 1805 that supports transmission configuration indicator state identification in wireless communications in accordance with aspects of the present disclosure. The device 1805 may be an example of or include the components of a device 1505, a device 1605, or a base station 105 as described herein. The device 1805 may communicate wirelessly with one or more base stations 105, UEs 115, or any combination thereof. The device 1805 may include components for bi-directional voice and data communications including components for transmitting and receiving communications, such as a communications manager 1820, a network communications manager 1810, a transceiver 1815, an antenna 1825, a memory 1830, code 1835, a processor 1840, and an inter-station communications manager 1845. These components may be in electronic communication or otherwise coupled (e.g., operatively, communicatively, functionally, electronically, electrically) via one or more buses (e.g., a bus 1850).

The network communications manager 1810 may manage communications with a core network 130 (e.g., via one or more wired backhaul links). For example, the network communications manager 1810 may manage the transfer of data communications for client devices, such as one or more UEs 115.

In some cases, the device 1805 may include a single antenna 1825. However, in some other cases the device 1805 may have more than one antenna 1825, which may be capable of concurrently transmitting or receiving multiple wireless transmissions. The transceiver 1815 may communicate bi-directionally, via the one or more antennas 1825, wired, or wireless links as described herein. For example, the transceiver 1815 may represent a wireless transceiver and may communicate bi-directionally with another wireless transceiver. The transceiver 1815 may also include a modem to modulate the packets, to provide the modulated packets to one or more antennas 1825 for transmission, and to demodulate packets received from the one or more antennas 1825. The transceiver 1815, or the transceiver 1815 and one or more antennas 1825, may be an example of a transmitter 1515, a transmitter 1615, a receiver 1510, a receiver 1610, or any combination thereof or component thereof, as described herein.

The memory 1830 may include RAM and ROM. The memory 1830 may store computer-readable, computer-executable code 1835 including instructions that, when executed by the processor 1840, cause the device 1805 to perform various functions described herein. The code 1835 may be stored in a non-transitory computer-readable medium such as system memory or another type of memory. In some cases, the code 1835 may not be directly executable by the processor 1840 but may cause a computer (e.g., when compiled and executed) to perform functions described herein. In some cases, the memory 1830 may contain, among other things, a BIOS which may control basic hardware or software operation such as the interaction with peripheral components or devices.

The processor 1840 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1840 may be configured to operate a memory array using a memory controller. In some other cases, a memory controller may be integrated into the processor 1840. The processor 1840 may be configured to execute computer-readable instructions stored in a memory (e.g., the memory 1830) to cause the device 1805 to perform various functions (e.g., functions or tasks supporting transmission configuration indicator state identification in wireless communications). For example, the device 1805 or a component of the device 1805 may include a processor 1840 and memory 1830 coupled with or to the processor 1840, the processor 1840 and memory 1830 configured to perform various functions described herein.

The inter-station communications manager 1845 may manage communications with other base stations 105, and may include a controller or scheduler for controlling communications with UEs 115 in cooperation with other base stations 105. For example, the inter-station communications manager 1845 may coordinate scheduling for transmissions to UEs 115 for various interference mitigation techniques such as beamforming or joint transmission. In some examples, the inter-station communications manager 1845 may provide an X2 interface within an LTE/LTE-A wireless communications network technology to provide communication between base stations 105.

The communications manager 1820 may support wireless communication at a network entity in accordance with examples as disclosed herein. For example, the communications manager 1820 may be configured as or otherwise support a means for transmitting, to a UE, control signaling identifying two or more transmission configuration indicator states that are to be applied to communications of one or more channels subsequent to a determined time. The communications manager 1820 may be configured as or otherwise support a means for transmitting, to the UE, control information associated with one or more resource allocations for communications after the determined time. The communications manager 1820 may be configured as or otherwise support a means for communicating with the UE via the one or more channels according to a first transmission configuration indicator state of the two or more transmission configuration indicator states based on a parameter associated with the control information and the two or more transmission configuration indicator states.

By including or configuring the communications manager 1820 in accordance with examples as described herein, the device 1805 may support techniques for selection of one or more particular TCI states for a one or more communications where multiple TCI states are configured, which may provide for reduced signaling overhead, increased flexibility, more efficient use of spatial resources, decreased collisions and interference, increased reliability of communications, and improved user experience.

In some examples, the communications manager 1820 may be configured to perform various operations (e.g., receiving, monitoring, transmitting) using or otherwise in cooperation with the transceiver 1815, the one or more antennas 1825, or any combination thereof. Although the communications manager 1820 is illustrated as a separate component, in some examples, one or more functions described with reference to the communications manager 1820 may be supported by or performed by the processor 1840, the memory 1830, the code 1835, or any combination thereof. For example, the code 1835 may include instructions executable by the processor 1840 to cause the device 1805 to perform various aspects of transmission configuration indicator state identification in wireless communications as described herein, or the processor 1840 and the memory 1830 may be otherwise configured to perform or support such operations.

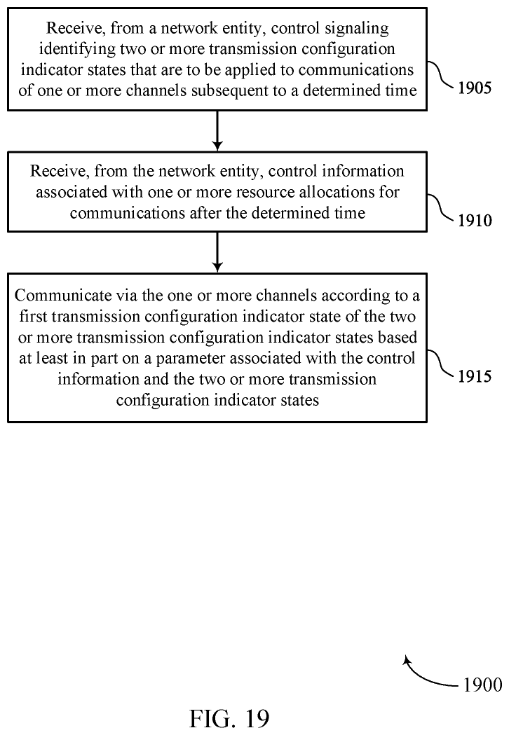

FIG. 19 shows a flowchart illustrating a method 1900 that supports transmission configuration indicator state identification in wireless communications in accordance with aspects of the present disclosure. The operations of the method 1900 may be implemented by a UE or its components as described herein. For example, the operations of the method 1900 may be performed by a UE 115 as described with reference to FIGS. 1 through 14. In some examples, a UE may execute a set of instructions to control the functional elements of the UE to perform the described functions. Additionally or alternatively, the UE may perform aspects of the described functions using special-purpose hardware.

At 1905, the method may include receiving, from a network entity, control signaling identifying two or more transmission configuration indicator states that are to be applied to communications of one or more channels subsequent to a determined time. The operations of 1905 may be performed in accordance with examples as disclosed herein. In some examples, aspects of the operations of 1905 may be performed by a TCI configuration manager 1325 as described with reference to FIG. 13.

At 1910, the method may include receiving, from the network entity, control information associated with one or more resource allocations for communications after the determined time. The operations of 1910 may be performed in accordance with examples as disclosed herein. In some examples, aspects of the operations of 1910 may be performed by a resource allocation manager 1330 as described with reference to FIG. 13.

At 1915, the method may include communicating via the one or more channels according to a first transmission configuration indicator state of the two or more transmission configuration indicator states based on a parameter associated with the control information and the two or more transmission configuration indicator states. The operations of 1915 may be performed in accordance with examples as disclosed herein. In some examples, aspects of the operations of 1915 may be performed by a TCI state selection manager 1335 as described with reference to FIG. 13.

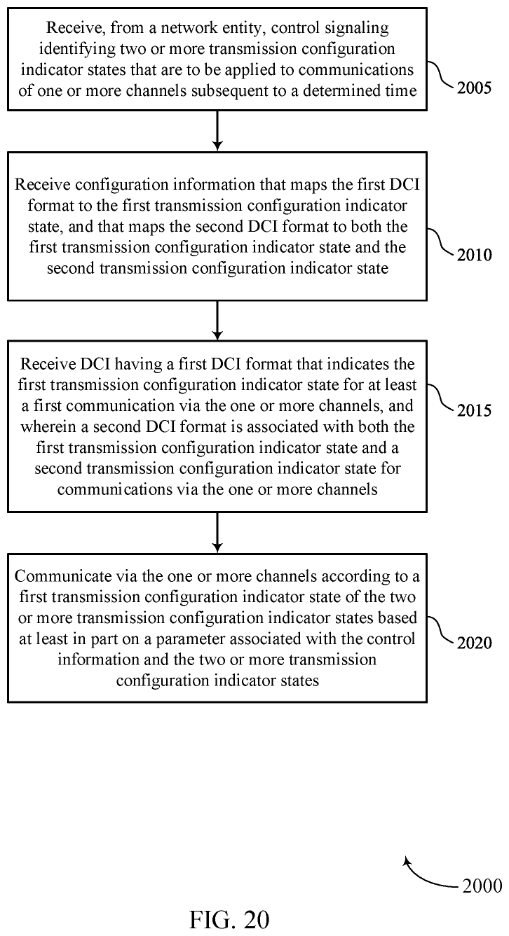

FIG. 20 shows a flowchart illustrating a method 2000 that supports transmission configuration indicator state identification in wireless communications in accordance with aspects of the present disclosure. The operations of the method 2000 may be implemented by a UE or its components as described herein. For example, the operations of the method 2000 may be performed by a UE 115 as described with reference to FIGS. 1 through 14. In some examples, a UE may execute a set of instructions to control the functional elements of the UE to perform the described functions. Additionally or alternatively, the UE may perform aspects of the described functions using special-purpose hardware.

At 2005, the method may include receiving, from a network entity, control signaling identifying two or more transmission configuration indicator states that are to be applied to communications of one or more channels subsequent to a determined time. The operations of 2005 may be performed in accordance with examples as disclosed herein. In some examples, aspects of the operations of 2005 may be performed by a TCI configuration manager 1325 as described with reference to FIG. 13.

At 2010, the method may include receiving configuration information that maps the first DCI format to the first transmission configuration indicator state, and that maps the second DCI format to both the first transmission configuration indicator state and the second transmission configuration indicator state. The operations of 2010 may be performed in accordance with examples as disclosed herein. In some examples, aspects of the operations of 2010 may be performed by a TCI state selection manager 1335 as described with reference to FIG. 13.

At 2015, the method may include receiving DCI having a first DCI format that indicates the first transmission configuration indicator state for at least a first communication via the one or more channels, and where a second DCI format is associated with both the first transmission configuration indicator state and a second transmission configuration indicator state for communications via the one or more channels. The operations of 2015 may be performed in accordance with examples as disclosed herein. In some examples, aspects of the operations of 2015 may be performed by a resource allocation manager 1330 as described with reference to FIG. 13.

At 2020, the method may include communicating via the one or more channels according to a first transmission configuration indicator state of the two or more transmission configuration indicator states based on a parameter associated with the control information and the two or more transmission configuration indicator states. The operations of 2020 may be performed in accordance with examples as disclosed herein. In some examples, aspects of the operations of 2020 may be performed by a TCI state selection manager 1335 as described with reference to FIG. 13.

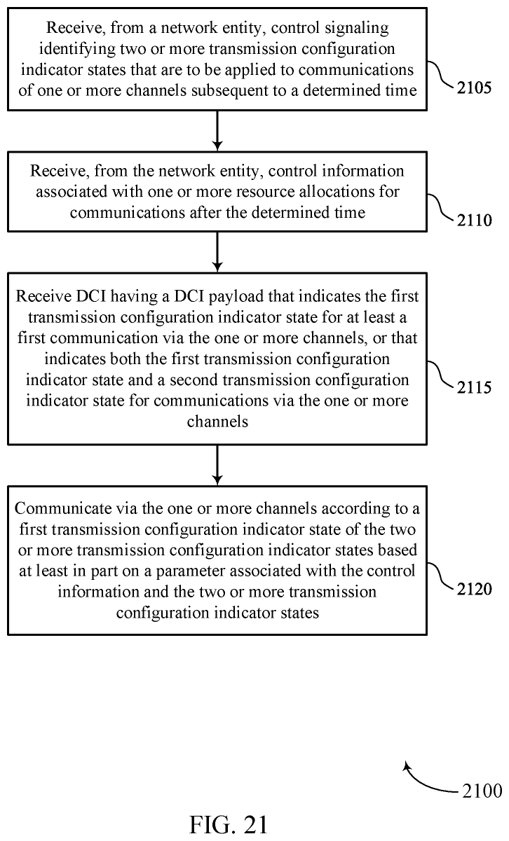

FIG. 21 shows a flowchart illustrating a method 2100 that supports transmission configuration indicator state identification in wireless communications in accordance with aspects of the present disclosure. The operations of the method 2100 may be implemented by a UE or its components as described herein. For example, the operations of the method 2100 may be performed by a UE 115 as described with reference to FIGS. 1 through 14. In some examples, a UE may execute a set of instructions to control the functional elements of the UE to perform the described functions. Additionally or alternatively, the UE may perform aspects of the described functions using special-purpose hardware.

At 2105, the method may include receiving, from a network entity, control signaling identifying two or more transmission configuration indicator states that are to be applied to communications of one or more channels subsequent to a determined time. The operations of 2105 may be performed in accordance with examples as disclosed herein. In some examples, aspects of the operations of 2105 may be performed by a TCI configuration manager 1325 as described with reference to FIG. 13.

At 2110, the method may include receiving, from the network entity, control information associated with one or more resource allocations for communications after the determined time. The operations of 2110 may be performed in accordance with examples as disclosed herein. In some examples, aspects of the operations of 2110 may be performed by a resource allocation manager 1330 as described with reference to FIG. 13.

At 2115, the method may include receiving DCI having a DCI payload that indicates the first transmission configuration indicator state for at least a first communication via the one or more channels, or that indicates both the first transmission configuration indicator state and a second transmission configuration indicator state for communications via the one or more channels. The operations of 2115 may be performed in accordance with examples as disclosed herein. In some examples, aspects of the operations of 2115 may be performed by a DCI payload manager 1340 as described with reference to FIG. 13.

At 2120, the method may include communicating via the one or more channels according to a first transmission configuration indicator state of the two or more transmission configuration indicator states based on a parameter associated with the control information and the two or more transmission configuration indicator states. The operations of 2120 may be performed in accordance with examples as disclosed herein. In some examples, aspects of the operations of 2120 may be performed by a TCI state selection manager 1335 as described with reference to FIG. 13.

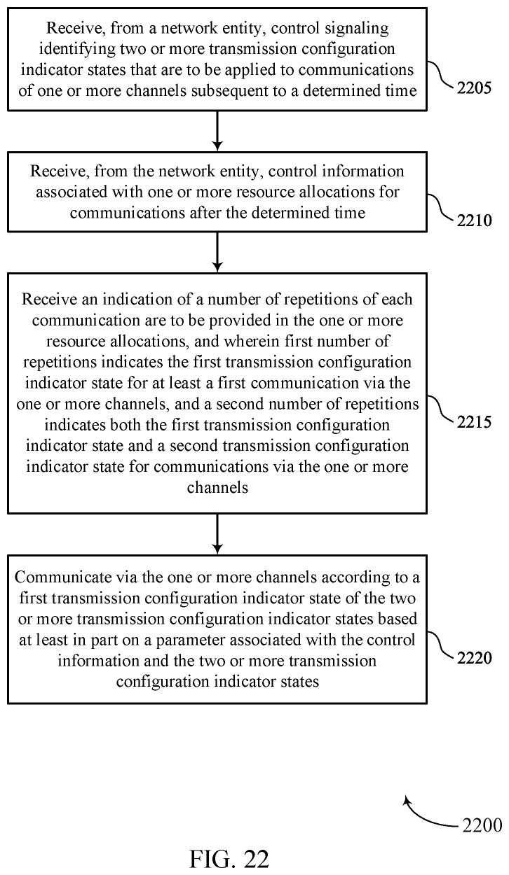

FIG. 22 shows a flowchart illustrating a method 2200 that supports transmission configuration indicator state identification in wireless communications in accordance with aspects of the present disclosure. The operations of the method 2200 may be implemented by a UE or its components as described herein. For example, the operations of the method 2200 may be performed by a UE 115 as described with reference to FIGS. 1 through 14. In some examples, a UE may execute a set of instructions to control the functional elements of the UE to perform the described functions. Additionally or alternatively, the UE may perform aspects of the described functions using special-purpose hardware.

At 2205, the method may include receiving, from a network entity, control signaling identifying two or more transmission configuration indicator states that are to be applied to communications of one or more channels subsequent to a determined time. The operations of 2205 may be performed in accordance with examples as disclosed herein. In some examples, aspects of the operations of 2205 may be performed by a TCI configuration manager 1325 as described with reference to FIG. 13.

At 2210, the method may include receiving, from the network entity, control information associated with one or more resource allocations for communications after the determined time. The operations of 2210 may be performed in accordance with examples as disclosed herein. In some examples, aspects of the operations of 2210 may be performed by a resource allocation manager 1330 as described with reference to FIG. 13.

At 2215, the method may include receiving an indication of a number of repetitions of each communication are to be provided in the one or more resource allocations, and where first number of repetitions indicates the first transmission configuration indicator state for at least a first communication via the one or more channels, and a second number of repetitions indicates both the first transmission configuration indicator state and a second transmission configuration indicator state for communications via the one or more channels. The operations of 2215 may be performed in accordance with examples as disclosed herein. In some examples, aspects of the operations of 2215 may be performed by a resource allocation manager 1330 as described with reference to FIG. 13.

At 2220, the method may include communicating via the one or more channels according to a first transmission configuration indicator state of the two or more transmission configuration indicator states based on a parameter associated with the control information and the two or more transmission configuration indicator states. The operations of 2220 may be performed in accordance with examples as disclosed herein. In some examples, aspects of the operations of 2220 may be performed by a TCI state selection manager 1335 as described with reference to FIG. 13.

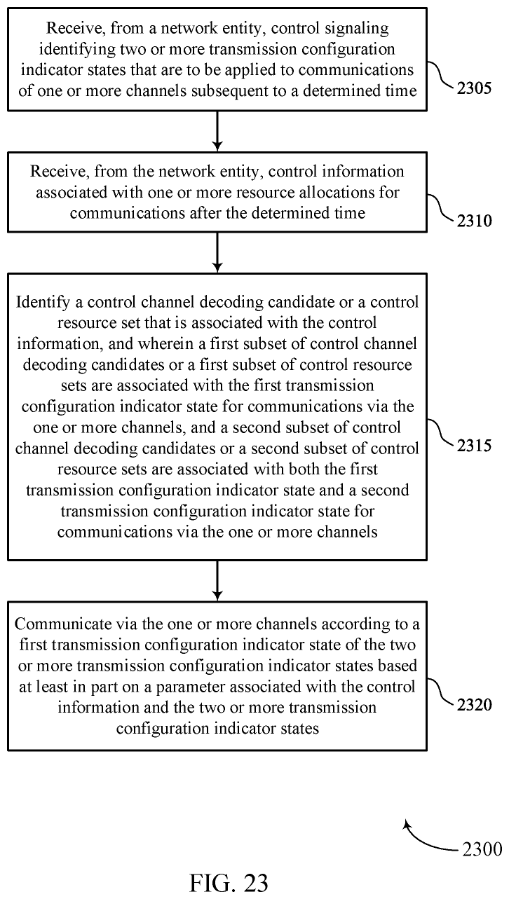

FIG. 23 shows a flowchart illustrating a method 2300 that supports transmission configuration indicator state identification in wireless communications in accordance with aspects of the present disclosure. The operations of the method 2300 may be implemented by a UE or its components as described herein. For example, the operations of the method 2300 may be performed by a UE 115 as described with reference to FIGS. 1 through 14. In some examples, a UE may execute a set of instructions to control the functional elements of the UE to perform the described functions. Additionally or alternatively, the UE may perform aspects of the described functions using special-purpose hardware.

At 2305, the method may include receiving, from a network entity, control signaling identifying two or more transmission configuration indicator states that are to be applied to communications of one or more channels subsequent to a determined time. The operations of 2305 may be performed in accordance with examples as disclosed herein. In some examples, aspects of the operations of 2305 may be performed by a TCI configuration manager 1325 as described with reference to FIG. 13.

At 2310, the method may include receiving, from the network entity, control information associated with one or more resource allocations for communications after the determined time. The operations of 2310 may be performed in accordance with examples as disclosed herein. In some examples, aspects of the operations of 2310 may be performed by a resource allocation manager 1330 as described with reference to FIG. 13.

At 2315, the method may include identifying a control channel decoding candidate or a control resource set that is associated with the control information, and where a first subset of control channel decoding candidates or a first subset of control resource sets are associated with the first transmission configuration indicator state for communications via the one or more channels, and a second subset of control channel decoding candidates or a second subset of control resource sets are associated with both the first transmission configuration indicator state and a second transmission configuration indicator state for communications via the one or more channels. The operations of 2315 may be performed in accordance with examples as disclosed herein. In some examples, aspects of the operations of 2315 may be performed by a TCI state selection manager 1335 as described with reference to FIG. 13.

At 2320, the method may include communicating via the one or more channels according to a first transmission configuration indicator state of the two or more transmission configuration indicator states based on a parameter associated with the control information and the two or more transmission configuration indicator states. The operations of 2320 may be performed in accordance with examples as disclosed herein. In some examples, aspects of the operations of 2320 may be performed by a TCI state selection manager 1335 as described with reference to FIG. 13.

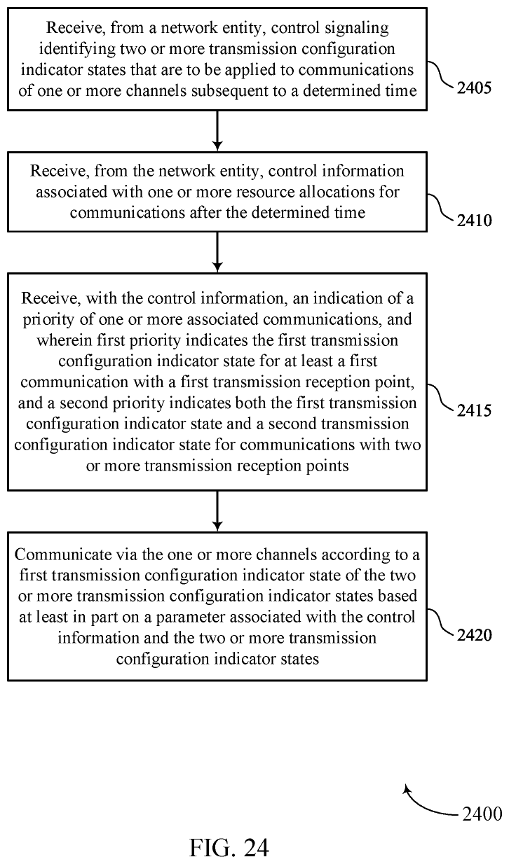

FIG. 24 shows a flowchart illustrating a method 2400 that supports transmission configuration indicator state identification in wireless communications in accordance with aspects of the present disclosure. The operations of the method 2400 may be implemented by a UE or its components as described herein. For example, the operations of the method 2400 may be performed by a UE 115 as described with reference to FIGS. 1 through 14. In some examples, a UE may execute a set of instructions to control the functional elements of the UE to perform the described functions. Additionally or alternatively, the UE may perform aspects of the described functions using special-purpose hardware.

At 2405, the method may include receiving, from a network entity, control signaling identifying two or more transmission configuration indicator states that are to be applied to communications of one or more channels subsequent to a determined time. The operations of 2405 may be performed in accordance with examples as disclosed herein. In some examples, aspects of the operations of 2405 may be performed by a TCI configuration manager 1325 as described with reference to FIG. 13.

At 2410, the method may include receiving, from the network entity, control information associated with one or more resource allocations for communications after the determined time. The operations of 2410 may be performed in accordance with examples as disclosed herein. In some examples, aspects of the operations of 2410 may be performed by a resource allocation manager 1330 as described with reference to FIG. 13.

At 2415, the method may include receiving, with the control information, an indication of a priority of one or more associated communications, and where first priority indicates the first transmission configuration indicator state for at least a first communication with a first transmission reception point, and a second priority indicates both the first transmission configuration indicator state and a second transmission configuration indicator state for communications with two or more transmission reception points. The operations of 2415 may be performed in accordance with examples as disclosed herein. In some examples, aspects of the operations of 2415 may be performed by a priority manager 1345 as described with reference to FIG. 13.

At 2420, the method may include communicating via the one or more channels according to a first transmission configuration indicator state of the two or more transmission configuration indicator states based on a parameter associated with the control information and the two or more transmission configuration indicator states. The operations of 2420 may be performed in accordance with examples as disclosed herein. In some examples, aspects of the operations of 2420 may be performed by a TCI state selection manager 1335 as described with reference to FIG. 13.

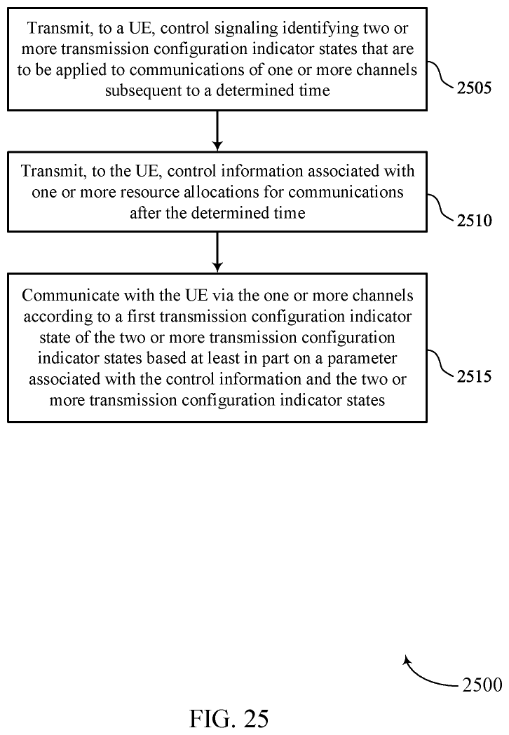

FIG. 25 shows a flowchart illustrating a method 2500 that supports transmission configuration indicator state identification in wireless communications in accordance with aspects of the present disclosure. The operations of the method 2500 may be implemented by a base station or its components as described herein. For example, the operations of the method 2500 may be performed by a base station 105 as described with reference to FIGS. 1 through 10 and 15 through 18. In some examples, a base station may execute a set of instructions to control the functional elements of the base station to perform the described functions. Additionally or alternatively, the base station may perform aspects of the described functions using special-purpose hardware.

At 2505, the method may include transmitting, to a UE, control signaling identifying two or more transmission configuration indicator states that are to be applied to communications of one or more channels subsequent to a determined time. The operations of 2505 may be performed in accordance with examples as disclosed herein. In some examples, aspects of the operations of 2505 may be performed by a TCI configuration manager 1725 as described with reference to FIG. 17.

At 2510, the method may include transmitting, to the UE, control information associated with one or more resource allocations for communications after the determined time. The operations of 2510 may be performed in accordance with examples as disclosed herein. In some examples, aspects of the operations of 2510 may be performed by a resource allocation manager 1730 as described with reference to FIG. 17.

At 2515, the method may include communicating with the UE via the one or more channels according to a first transmission configuration indicator state of the two or more transmission configuration indicator states based on a parameter associated with the control information and the two or more transmission configuration indicator states. The operations of 2515 may be performed in accordance with examples as disclosed herein. In some examples, aspects of the operations of 2515 may be performed by a TCI state selection manager 1735 as described with reference to FIG. 17.

The following provides an overview of aspects of the present disclosure:
Aspect 1: A method for wireless communication at a UE, comprising: receiving, from a network entity, control signaling identifying two or more transmission configuration indicator states that are to be applied to communications of one or more channels subsequent to a determined time; receiving, from the network entity, control information associated with one or more resource allocations for communications after the determined time; and communicating via the one or more channels according to a first transmission configuration indicator state of the two or more transmission configuration indicator states based at least in part on a parameter associated with the control information and the two or more transmission configuration indicator states.
Aspect 2: The method of aspect 1, wherein the two or more transmission configuration indicator states provide for multi-transmission reception point communications with two or more transmission reception points associated with the network entity.
Aspect 3: The method of any of aspects 1 through 2, wherein the receiving the control information comprises: receiving DCI having a first DCI format that indicates the first transmission configuration indicator state for at least a first communication via the one or more channels, and wherein a second DCI format is associated with both the first transmission configuration indicator state and a second transmission configuration indicator state for communications via the one or more channels.
Aspect 4: The method of aspect 3, wherein the first DCI format is associated with a first subset of DCI formats that schedule single transmission reception point communications using the first transmission configuration indicator state, and the second DCI format is associated with a second subset of DCI formats that schedule multi-transmission reception point communications using both the first transmission configuration indicator state and the second transmission configuration indicator state.
Aspect 5: The method of any of aspects 3 through 4, further comprising: receiving configuration information that maps the first DCI format to the first transmission configuration indicator state, and that maps the second DCI format to both the first transmission configuration indicator state and the second transmission configuration indicator state.
Aspect 6: The method of any of aspects 3 through 5, wherein the first transmission configuration indicator state applies to PDSCH communications, PUCCH communications, PUSCH communications, or any combinations thereof, that are scheduled by the first DCI format, and both the first transmission configuration indicator state and the second transmission configuration indicator state apply to PDSCH communications, PUCCH communications, PUSCH communications, or any combinations thereof, that are scheduled by the second DCI format.
Aspect 7: The method of any of aspects 1 through 6, wherein the receiving the control information comprises: receiving DCI having a DCI payload that indicates the first transmission configuration indicator state for at least a first communication via the one or more channels, or that indicates both the first transmission configuration indicator state and a second transmission configuration indicator state for communications via the one or more channels.
Aspect 8: The method of aspect 7, wherein the DCI payload is a one-bit field that indicates to use the first transmission configuration indicator state or to use both the first transmission configuration indicator state and the second transmission configuration indicator state.
Aspect 9: The method of any of aspect 7, wherein the DCI payload is a two-bit field that indicates to use the first transmission configuration indicator state, to use the second transmission configuration indicator state for communications with a second transmission reception point, or to use both the first transmission configuration indicator state and the second transmission configuration indicator state.
Aspect 10: The method of aspect 9, wherein the two-bit field further indicates an order for applying the first transmission configuration indicator state and the second transmission configuration indicator state to a first resource allocation of a first channel of the one or more channels and a second resource allocation or a second channel of the one or more channels.
Aspect 11: The method of any of aspects 1 through 10, wherein the receiving the control information comprises: receiving an indication of a number of repetitions of each communication are to be provided in the one or more resource allocations, and wherein first number of repetitions indicates the first transmission configuration indicator state for at least a first communication via the one or more channels, and a second number of repetitions indicates both the first transmission configuration indicator state and a second transmission configuration indicator state for communications via the one or more channels.
Aspect 12: The method of aspect 11, wherein the first transmission configuration indicator state used when the number of repetitions is a single repetition, and both the first transmission configuration indicator state and the second transmission configuration indicator state are used when the number of repetitions is two or more repetitions.
Aspect 13: The method of any of aspects 1 through 12, further comprising: identifying a control channel decoding candidate or a control resource set that is associated with the control information, and wherein a first subset of control channel decoding candidates or a first subset of control resource sets are associated with the first transmission configuration indicator state for communications via the one or more channels, and a second subset of control channel decoding candidates or a second subset of control resource sets are associated with both the first transmission configuration indicator state and a second transmission configuration indicator state for communications via the one or more channels.
Aspect 14: The method of aspect 13, wherein the first transmission configuration indicator state is associated with a single control channel decoding candidate, and both the first transmission configuration indicator state and the second transmission configuration indicator state are associated with multiple control channel decoding candidates for the control information, wherein the multiple control channel decoding candidates are linked for control information repetition across the multiple control channel decoding candidates.
Aspect 15: The method of any of aspects 13 through 14, wherein the first subset of control resource sets is associated with a single transmission configuration indicator state, and the second subset of control resource sets is associated with multiple transmission configuration indicator states.
Aspect 16: The method of any of aspects 1 through 15, wherein the receiving the control information comprises: receiving, with the control information, an indication of a priority of one or more associated communications, and wherein first priority indicates the first transmission configuration indicator state for at least a first communication with a first transmission reception point, and a second priority indicates both the first transmission configuration indicator state and a second transmission configuration indicator state for communications with two or more transmission reception points.
Aspect 17: The method of any of aspects 1 through 16, wherein the control information is a scheduling downlink control indication (DCI) that indicates allocated resources for communications, or is an activation DCI that activates communication using previously configured resources.
Aspect 18: The method of any of aspects 1 through 17, wherein the two or more transmission configuration indicator states are associated with multi-transmission reception point communications with two or more transmission reception points according to a time division multiplexing communications scheme, a frequency division multiplexing communications scheme, a spatial division multiplexing communications scheme, or a single frequency network communications scheme.
Aspect 19: The method of any of aspects 1 through 18, wherein the one or more channels include a downlink shared channel, uplink shared channel, uplink control channel, or any combinations thereof, and wherein the control signaling includes one or more of downlink control information having a first format with a transmission configuration indicator state field, or a medium access control (MAC) control element that indicates a single transmission configuration indicator codepoint that is mapped to the two or more transmission configuration indicator states.
Aspect 20: A method for wireless communication at a network entity, comprising: transmitting, to a UE, control signaling identifying two or more transmission configuration indicator states that are to be applied to communications of one or more channels subsequent to a determined time; transmitting, to the UE, control information associated with one or more resource allocations for communications after the determined time; and communicating with the UE via the one or more channels according to a first transmission configuration indicator state of the two or more transmission configuration indicator states based at least in part on a parameter associated with the control information and the two or more transmission configuration indicator states.
Aspect 21: The method of aspect 20, wherein the transmitting the control information comprises: transmitting DCI having a first DCI format that indicates the first transmission configuration indicator state for at least a first communication via the one or more channels, and wherein a second DCI format is associated with both the first transmission configuration indicator state and a second transmission configuration indicator state for communications via the one or more channels.
Aspect 22: The method of any of aspects 20 through 21, wherein the transmitting the control information comprises: transmitting DCI having a DCI payload that indicates the first transmission configuration indicator state for at least a first communication via the one or more channels, or that indicates both the first transmission configuration indicator state and a second transmission configuration indicator state for communications via the one or more channels.
Aspect 23: The method of any of aspects 20 through 22, wherein the transmitting the control information comprises: transmitting an indication of a number of repetitions of each communication are to be provided in the one or more resource allocations, and wherein first number of repetitions indicates the first transmission configuration indicator state for at least a first communication via the one or more channels, and a second number of repetitions indicates both the first transmission configuration indicator state and a second transmission configuration indicator state for communications via the one or more channels.
Aspect 24: The method of any of aspects 20 through 23, wherein a first subset of control channel decoding candidates or a first subset of control resource sets used for providing the control information are associated with the first transmission configuration indicator state for communications via the one or more channels, and a second subset of control channel decoding candidates or a second subset of control resource sets are associated with both the first transmission configuration indicator state and a second transmission configuration indicator state for communications via the one or more channels.
Aspect 25: The method of any of aspects 20 through 24, wherein the transmitting the control information comprises: transmitting, with the control information, an indication of a priority of one or more associated communications, and wherein first priority indicates the first transmission configuration indicator state for at least a first communication via the one or more channels, and a second priority indicates both the first transmission configuration indicator state and a second transmission configuration indicator state for communications via the one or more channels.
Aspect 26: An apparatus for wireless communication at a UE, comprising at least one processor, and memory coupled to the at least one processor, the memory storing instructions executable by the at least one processor to cause the apparatus to perform a method of any of aspects 1 through 19.
Aspect 27: An apparatus for wireless communication at a UE, comprising at least one means for performing a method of any of aspects 1 through 19.
Aspect 28: A non-transitory computer-readable medium storing code for wireless communication at a UE, the code comprising instructions executable by a processor to perform a method of any of aspects 1 through 19.
Aspect 29: An apparatus for wireless communication at a network entity, comprising at least one processor, and memory coupled to the at least one processor, the memory storing instructions executable by the at least one processor to cause the apparatus to perform a method of any of aspects 20 through 25.
Aspect 30: An apparatus for wireless communication at a network entity, comprising at least one means for performing a method of any of aspects 20 through 25.
Aspect 31: A non-transitory computer-readable medium storing code for wireless communication at a network entity, the code comprising instructions executable by a processor to perform a method of any of aspects 20 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a network entity, control signaling identifying two or more transmission configuration indicator states that are to be applied to communications of one or more channels subsequent to a determined time;
receiving, from the network entity, control information associated with one or more resource allocations for communications after the determined time; and
communicating via the one or more channels according to a first transmission configuration indicator state of the two or more transmission configuration indicator states based at least in part on a parameter associated with the control information and the two or more transmission configuration indicator states.

2. The method of claim 1, wherein the two or more transmission configuration indicator states provide for multi-transmission reception point communications with two or more transmission reception points associated with the network entity.

3. The method of claim 1, wherein the receiving the control information comprises:
receiving downlink control information (DCI) having a first DCI format that indicates the first transmission configuration indicator state for at least a first communication via the one or more channels, and wherein a second DCI format is associated with both the first transmission configuration indicator state and a second transmission configuration indicator state for communications via the one or more channels.

4. The method of claim 3, wherein the first DCI format is associated with a first subset of DCI formats that schedule single transmission reception point communications using the first transmission configuration indicator state, and the second DCI format is associated with a second subset of DCI formats that schedule multi-transmission reception point communications using both the first transmission configuration indicator state and the second transmission configuration indicator state.

5. The method of claim 3, further comprising:
receiving configuration information that maps the first DCI format to the first transmission configuration indicator state, and that maps the second DCI format to both the first transmission configuration indicator state and the second transmission configuration indicator state.

6. The method of claim 3, wherein:
the first transmission configuration indicator state applies to physical downlink shared channel (PDSCH) communications, physical uplink control channel (PUCCH) communications, physical uplink shared channel (PUSCH) communications, or any combinations thereof, that are scheduled by the first DCI format, and
both the first transmission configuration indicator state and the second transmission configuration indicator state apply to PDSCH communications, PUCCH communications, PUSCH communications, or any combinations thereof, that are scheduled by the second DCI format.

7. The method of claim 1, wherein the receiving the control information comprises:
receiving downlink control information (DCI) having a DCI payload that indicates the first transmission configuration indicator state for at least a first communication via the one or more channels, or that indicates both the first transmission configuration indicator state and a second transmission configuration indicator state for communications via the one or more channels.

8. The method of claim 7, wherein the DCI payload is a one-bit field that indicates to use the first transmission configuration indicator state or to use both the first transmission configuration indicator state and the second transmission configuration indicator state.

9. The method of claim 7, wherein the DCI payload is a two-bit field that indicates to use the first transmission configuration indicator state, to use the second transmission configuration indicator state for communications with a second transmission reception point, or to use both the first transmission configuration indicator state and the second transmission configuration indicator state.

10. The method of claim 9, wherein the two-bit field further indicates an order for applying the first transmission configuration indicator state and the second transmission configuration indicator state to a first resource allocation of a first channel of the one or more channels and a second resource allocation of the first channel or a second channel of the one or more channels.

11. The method of claim 1, wherein the receiving the control information comprises:
receiving an indication of a number of repetitions of each communication are to be provided in the one or more resource allocations, and wherein first number of repetitions indicates the first transmission configuration indicator state for at least a first communication via the one or more channels, and a second number of repetitions indicates both the first transmission configuration indicator state and a second transmission configuration indicator state for communications via the one or more channels.

12. The method of claim 11, wherein the first transmission configuration indicator state used when the number of repetitions is a single repetition, and both the first transmission configuration indicator state and the second transmission configuration indicator state are used when the number of repetitions is two or more repetitions.

13. The method of claim 1, further comprising:
identifying a control channel decoding candidate or a control resource set that is associated with the control information, and wherein a first subset of control channel decoding candidates or a first subset of control resource sets are associated with the first transmission configuration indicator state for communications via the one or more channels, and a second subset of control channel decoding candidates or a second subset of control resource sets are associated with both the first transmission configuration indicator state and a second transmission configuration indicator state for communications via the one or more channels.

14. The method of claim 13, wherein the first transmission configuration indicator state is associated with a single control channel decoding candidate, and both the first transmission configuration indicator state and the second transmission configuration indicator state are associated with multiple control channel decoding candidates for the control information, wherein the multiple control channel decoding candidates are linked for control information repetition across the multiple control channel decoding candidates.

15. The method of claim 13, wherein the first subset of control resource sets is associated with a single transmission configuration indicator state, and the second subset of control resource sets is associated with multiple transmission configuration indicator states.

16. The method of claim 1, wherein the receiving the control information comprises:
receiving, with the control information, an indication of a priority of one or more associated communications, and wherein first priority indicates the first transmission configuration indicator state for at least a first communication with a first transmission reception point, and a second priority indicates both the first transmission configuration indicator state and a second transmission configuration indicator state for communications with two or more transmission reception points.

17. The method of claim 1, wherein the control information is a scheduling downlink control indication (DCI) that indicates allocated resources for communications, or is an activation DCI that activates communication using previously configured resources.

18. The method of claim 1, wherein the two or more transmission configuration indicator states are associated with multi-transmission reception point communications with two or more transmission reception points according to a time division multiplexing communications scheme, a frequency division multiplexing communications scheme, a spatial division multiplexing communications scheme, or a single frequency network communications scheme.

19. The method of claim 1, wherein:
the one or more channels include a downlink shared channel, uplink shared channel, uplink control channel, or any combinations thereof, and wherein
the control signaling includes one or more of downlink control information having a first format with a transmission configuration indicator state field, or a medium access control (MAC) control element that indicates a single transmission configuration indicator codepoint that is mapped to the two or more transmission configuration indicator states.

20. A method for wireless communication at a network entity, comprising:
transmitting, to a user equipment (UE), control signaling identifying two or more transmission configuration indicator states that are to be applied to communications of one or more channels subsequent to a determined time;
transmitting, to the UE, control information associated with one or more resource allocations for communications after the determined time; and
communicating with the UE via the one or more channels according to a first transmission configuration indicator state of the two or more transmission configuration indicator states based at least in part on a parameter associated with the control information and the two or more transmission configuration indicator states.

21. The method of claim 20, wherein the transmitting the control information comprises:
transmitting downlink control information (DCI) having a first DCI format that indicates the first transmission configuration indicator state for at least a first communication via the one or more channels, and wherein a second DCI format is associated with both the first transmission configuration indicator state and a second transmission configuration indicator state for communications via the one or more channels.

22. The method of claim 20, wherein the transmitting the control information comprises:
transmitting downlink control information (DCI) having a DCI payload that indicates the first transmission configuration indicator state for at least a first communication via the one or more channels, or that indicates both the first transmission configuration indicator state and a second transmission configuration indicator state for communications via the one or more channels.

23. The method of claim 20, wherein the transmitting the control information comprises:
transmitting an indication of a number of repetitions of each communication are to be provided in the one or more resource allocations, and wherein first number of repetitions indicates the first transmission configuration indicator state for at least a first communication via the one or more channels, and a second number of repetitions indicates both the first transmission configuration indicator state and a second transmission configuration indicator state for communications via the one or more channels.

24. The method of claim 20, wherein a first subset of control channel decoding candidates or a first subset of control resource sets used for providing the control information are associated with the first transmission configuration indicator state for communications via the one or more channels, and a second subset of control channel decoding candidates or a second subset of control resource sets are associated with both the first transmission configuration indicator state and a second transmission configuration indicator state for communications via the one or more channels.

25. The method of claim 20, wherein the transmitting the control information comprises:
transmitting, with the control information, an indication of a priority of one or more associated communications, and wherein first priority indicates the first transmission configuration indicator state for at least a first communication via the one or more channels, and a second priority indicates both the first transmission configuration indicator state and a second transmission configuration indicator state for communications via the one or more channels.

26. An apparatus for wireless communication at a user equipment (UE), comprising:
at least one processor; and
memory coupled to the at least one processor, the memory storing instructions executable by the at least one processor to cause the apparatus to:
receive, from a network entity, control signaling identifying two or more transmission configuration indicator states that are to be applied to communications of one or more channels subsequent to a determined time;
receive, from the network entity, control information associated with one or more resource allocations for communications after the determined time; and
communicate via the one or more channels according to a first transmission configuration indicator state of the two or more transmission configuration indicator states based at least in part on a parameter associated with the control information and the two or more transmission configuration indicator states.

27. The apparatus of claim 26, wherein the two or more transmission configuration indicator states provide for multi-transmission reception point communications with two or more transmission reception points associated with the network entity.

28. The apparatus of claim 26, wherein the control information is a scheduling downlink control indication (DCI) that indicates allocated resources for communications, or is an activation DCI that activates communication using previously configured resources.

29. An apparatus for wireless communication at a network entity, comprising:
at least one processor; and
memory coupled to the at least one processor, the memory storing instructions executable by the at least one processor to cause the apparatus to:
transmit, to a user equipment (UE), control signaling identifying two or more transmission configuration indicator states that are to be applied to communications of one or more channels subsequent to a determined time;
transmit, to the UE, control information associated with one or more resource allocations for communications after the determined time; and
communicate with the UE via the one or more channels according to a first transmission configuration indicator state of the two or more transmission configuration indicator states based at least in part on a parameter associated with the control information and the two or more transmission configuration indicator states.

30. The apparatus of claim 29, wherein the instructions to transmit the control information are executable by the at least one processor to cause the apparatus to:
transmit downlink control information (DCI) having a first DCI format that indicates the first transmission configuration indicator state for at least a first communication via the one or more channels, and wherein a second DCI format is associated with both the first transmission configuration indicator state and a second transmission configuration indicator state for communications via the one or more channels.
